(19) United States
(12) Patent Application Publication
(10) Pub. No.: US 2023/0021003 A1
(43) Pub. Date: Jan. 19, 2023

(54) INFORMATION PROCESSING APPARATUS, INFORMATION PROCESSING METHOD, AND NON-TRANSITORY COMPUTER READABLE STORAGE

(71) Applicant: JAPAN COMPUTER VISION CORP., Tokyo (JP)

(72) Inventors: Nozomu HAYASHIDA, Tokyo (JP); Kanako DOHI, Tokyo (JP); Masayuki MOTOSHIMA, Tokyo (JP); Tatsuaki BANDO, Tokyo (JP)

(73) Assignee: JAPAN COMPUTER VISION CORP., Tokyo (JP)

(21) Appl. No.: 17/529,028

(22) Filed: Nov. 17, 2021

(30) Foreign Application Priority Data
Jul. 14, 2021 (JP) 2021-116069

(51) Int. Cl. G06K 9/00; G06Q 30/02

(52) U.S. Cl. CPC G06K 9/00295; G06K 9/00926; G06Q 30/0201

(57) ABSTRACT

An information processing apparatus includes an acquiring unit, a determining unit, and a notifying unit. The acquiring unit acquires a facial image of a first visitor that has visited a predetermined place to be visited, and attribute information indicating an attribute of the first visitor at a time of visit. The determining unit determines when a second visitor visits the predetermined place to be visited, whether a same person as the second visitor is included among the first visitors by verification between a facial image of the first and second visitor. The notifying unit notifies, when attribute information corresponding to the first visitor that has been determined as the same person as the second visitor indicates a specific attribute, that a subject person, an attribute of which is the specific attribute at least at the time of visit has visited again as the second visitor.

### CROSS-REFERENCE TO RELATED APPLICATION(S)

The present application claims priority to and incorporates by reference the entire contents of Japanese Patent Application No. 2021-116069 filed in Japan on Jul. 14, 2021.

### BACKGROUND OF THE INVENTION

### 1. Field of the Invention

The present invention relates to an information processing apparatus, an information processing method, and a non-transitory computer readable storage medium.

### 2. Description of the Related Art

Conventionally, systems for managing visitors by face recognition have been proposed. For example, U.S. Pat. No. 6,858,914 discloses a locking system that unlocks an entrance door with a locking device by performing authentication using facial images of a visitor imaged by an imaging device.

However, in the above conventional technique, it is not necessarily possible to effectively track future visits of a visitor that is determined to of a specific attribute.

For example, in the above conventional technique, authentication is performed by comparing the facial image of the visitor captured by an imaging device arranged at an entrance with information relating to a recorded facial image of the visitor, and by comparing a date and time at which the facial image is captured and a visiting date and time registered in advance, and when the authentication succeeds, an unlocking instruction is transmitted to the locking device, and completion of unlocking is notified to the owner.

As described, in the above conventional technique, because the entrance door is unlocked simply when authentication succeeds based on a facial image of a visitor and a date and time at which the facial image is captured, it is not necessarily possible to effectively track, for example, future visits of a visitor that has been determined to be of a specific attribute.

### SUMMARY OF THE INVENTION

It is an object of the present invention to at least partially solve the problems in the conventional technology.

According to one aspect of an embodiment, an information processing apparatus includes an acquiring unit that acquires a facial image of a first visitor that has visited a predetermined place to be visited, and attribute information indicating an attribute of the first visitor at a time of visit. The information processing apparatus includes a determining unit that determines, when a second visitor visits the predetermined place to be visited, whether a same person as the second visitor is included among the first visitor by verification between a facial image of the first visitor and a facial image of the second visitor. The information processing apparatus includes a notifying unit that notifies, when attribute information corresponding to the first visitor that has been determined as the same person as the second visitor indicates a specific attribute, that a subject person, an attribute of which is the specific attribute at least at the time of visit has visited again as the second visitor.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an overview of information processing according to an embodiment;

FIG. 2 is a diagram illustrating an example of a scene to which the information processing according to the embodiment is applicable as a service;

FIG. 3 is a diagram illustrating a configuration example of an information processing apparatus according to the embodiment;

FIG. 4 is a diagram illustrating an example of a capture history database according to the embodiment;

FIG. 5 is a diagram illustrating an example of a visitor information database according to the embodiment;

FIG. 6 is a diagram illustrating an example of a tag information database according to the embodiment;

FIG. 7 is a diagram illustrating an example of a registered-person information database according to the embodiment;

FIG. 8 is a diagram illustrating an example of a notification setting database according to the embodiment;

FIG. 9 is a diagram illustrating an example of information processing relating to tag creation;

FIG. 10 is a diagram illustrating an example of information processing relating to tag addition;

FIG. 11 is a diagram illustrating an example of information processing relating to notification settings;

FIG. 12 is a diagram illustrating an example (1) of information processing relating to confirmation of settings;

FIG. 13 is a diagram illustrating an example (2) of information processing relating to confirmation of settings;

FIG. 14 is a diagram illustrating an example of a dashboard function of the information processing apparatus;

FIG. 15 is a sequence diagram illustrating a procedure of information processing according to the embodiment; and

FIG. 16 is a hardware configuration illustrating an example of a computer that implements functions of an information processing apparatus 100.

### DETAILED DESCRIPTION OF THE PREFERRED EMBODIMENTS

Hereinafter, a form (hereinafter, “embodiment”) to implement an information processing apparatus, an information processing method, and an information processing program according to the present application will be explained in detail with reference to the drawings. The embodiment is not intended to limit the information processing apparatus, the information processing method, and the information processing program according to the present application. Moreover, throughout respective embodiments, like reference symbols are assigned to like parts, and duplicated explanation will be omitted.

### 1. INTRODUCTION

A technique of controlling opening and closing of an entrance gate according to an authentication result by performing authentication of a person based on a captured image by a terminal device (for example, a terminal device having various kinds of sensors) installed at an entrance, or of doing a health check of a person from a body temperature detected by the terminal device has been known.

However, it is not necessarily satisfactory in a point of providing a service for a user so that the user can use information acquired from the terminal device effectively. For example, a service in which information relating to a visitor acquired from the terminal device can be used for crime prevention, sales promotion, customer management, and the like has been in demand.

In view of the above situation, in the present embodiment, a system in which a user can manage visitors appropriately is provided as a service for users. For example, there is a case in which a user wishes to track future visits of a visitor that has been determined to be of a specific attribute (for example, VIP, suspicious individual, and the like). According to such a situation, in the present embodiment, a visitor is tagged with attribute information indicating a specific attribute. Moreover, in the present embodiment, by a face recognition technique using a facial image of the visitor, future visits of the tagged visitor are detected, and various kinds of notification according to a detection result can be thereby performed.

### 2. OVERVIEW OF INFORMATION PROCESSING

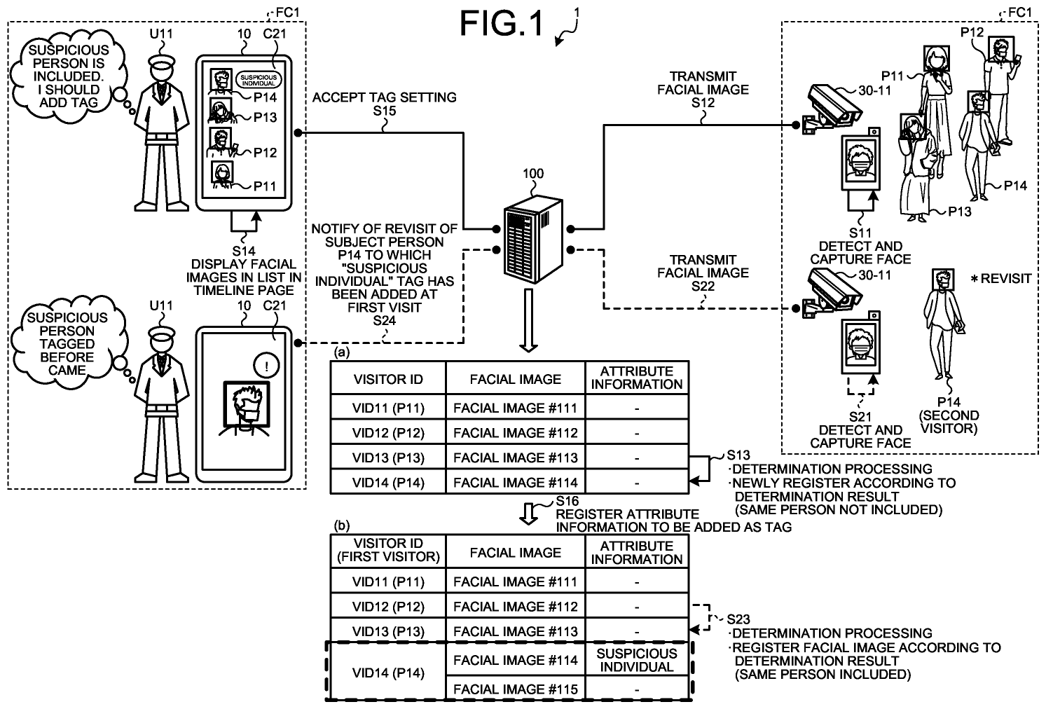

First, an overview of information processing according to the embodiment will be explained by using FIG. 1. FIG. 1 is a diagram for explaining an overview of information processing according to the embodiment. The information processing illustrated in FIG. 1 is implemented by an information processing system 1.

### 2-1. Information Processing System

The information processing system 1 includes a terminal device 10 that is used by a user that is a user of a service corresponding to the information processing according to the embodiment, and that belongs to predetermined facility (hereinafter, simply “user”), an imaging device 30 that is installed at an entrance of the predetermined facility, and an information processing apparatus 100 that is a main apparatus that performs the information processing according to the embodiment. The terminal device 10, the imaging device 30, and the information processing apparatus 100 are wiredly or wirelessly connected through a predetermined network N (not illustrated) in a communication-enabled manner. The information processing system 1 illustrated in FIG. 1 may include the arbitrary number of terminal devices 10, the arbitrary number of imaging devices 30, and the arbitrary number of information processing apparatuses 100.

The terminal device 10 is an information processing device that is used by a user. The terminal device 10 is implemented by, for example, a smartphone, a tablet terminal, a laptop personal computer (PC), a desktop PC, a mobile phone, a personal digital assistant (PDA), and the like. The terminal device 10 performs various kinds of information processing with respect to the information processing apparatus 100 according to an operation made by the user. Moreover, for example, the terminal device 10 displays information sent from the information processing apparatus 100 on a display screen.

Furthermore, to the terminal device 10, a predetermined application to implement transmission and reception of information with the information processing apparatus 100 may be introduced. The application may be, for example, a general-purpose application as browser, or may be a dedicated application that supports the information processing according to the embodiment.

The imaging device 30 is an information processing apparatus including an imaging function (camera), and may be installed at an entrance of a predetermined facility. For example, the imaging device 30 has a function of capturing, when a face of a visitor that visits the predetermined facility is detected, a facial image of the detected face. Moreover, the imaging device 30 may have a function of detecting a body temperature of a visitor that visits the predetermined facility. The terminal device 10 may be implemented, for example, by a tablet terminal, an IP camera, or the like.

The information processing apparatus 100 provides various kinds of services for visitor management to a user by performing the information processing according to the embodiment. The information processing apparatus 100 is implemented, for example, by a server device. Moreover, when the terminal device 10 and the imaging device 30 are so-called edge computer that performs edge processing at a position close to the user, the information processing apparatus 100 may be a cloud computer that is present on a cloud.

### 2-2. Specific Example of Information Processing

Subsequently, a specific example of the information processing according to the embodiment will be explained by using FIG. 1. FIG. 1 illustrates an example in which an imaging device 30-11 (one example of the imaging device 30) is installed at an entrance of a store FC1 (one example of the predetermined facility). Moreover, FIG. 1 illustrates an example in which information settings according to a facial image captured by the imaging device 30-11 is performed with respect to the information processing apparatus 100 by using the terminal device 10, and an example in which a user U11 that belongs to the store FC1 receives notification about a visitor from the information processing apparatus 100. Furthermore, the user U11 may be any kind of person as long as the person is someone related to the store FC1. For example, the user U11 may be a person belonging to the store FC1, but in the example in FIG. 1, the user U11 is supposed to be a security guard hired by the store FC1. The user FC1 may be a salesperson of the store FC1, an owner of the store FC1, or the like. Moreover, the user U11 may be a consultant contracted by the owner of the store FC1.

Furthermore, in FIG. 1, information processing (steps S11 to S16) relating to tag settings for a tracking purpose is indicted by a solid line. On the other hand, in FIG. 1, information processing (step S21 to S24) relating to visit notification according to the tag settings is indicated by a dotted line.

First, an example of the information processing relating to the tag settings will be explained. In this example, it will be explained, supposing that persons P11, P12, P13, and P14 visit the store FC1 for the first time. At the first visit as this case, the persons P11, P12, P13, and P14 are strangers for the store FC1.

For example, the imaging device 30-11 sequentially detects the respective persons as the persons P11, P12, P13, and P14 sequentially pass through the entrance of the store FC1, and captures a facial image of a person at each detection (step S11).

Next, the imaging device 30-11 transmits a captured facial image to the information processing apparatus 100 (step S12). In the example in FIG. 1, it is assumed that the imaging device 30-11 transmits a facial image of the person P11, a facial image of the person P12, a facial image of the person P13, and a facial image of the person P14 to the information processing apparatus 100.

Having received the facial image from the imaging device 30-11, the information processing apparatus 100 performs same-person determination using arbitrary face recognition technique (step S13). Specifically, the information processing apparatus 100 compares facial images of other persons (first visitor) that have visited the store FC1 before with a facial image of the persons P11 to P14 (second visitor) visited the store FC1 this time, and thereby determines whether the same person as the second visitor is included among the first visitors. For example, the information processing apparatus 100 may have a database in which facial images of other persons that have visited the store FC1 before are registered as facial images of the first visitor, and can perform verification between the facial image of the first visitor registered in this database and the facial image of the second visitor acquired this time.

Specifically, the information processing apparatus 100 verifies each of the facial images of the first visitor registered in the database against a facial image #111 of the person P11, which is the second visitor. Moreover, the information processing apparatus 100 performs verification similarly for facial images of the other second visitors, namely, a facial image #112 of the person P12, a facial image #P113 of the person P13, a facial image #114 of the person P14 also.

As described above, the persons P11 to P14 are all visitors visiting the store FC1 for the first time, and are unknown customers for the store FC1. Therefore, at this point, the facial images of the persons P11 to P14 are not registered in the database. Therefore, the information processing apparatus 100 determines that the same person as the second visitor is not included among the first visitors as a result of verification of the facial images of the first visitors (other people that have visited the store FC1) against the facial images of the second visitors (persons P11 to P14).

Moreover, as a result of determining that the same person is not present as this case, at step S13, the information processing apparatus 100 registers the persons P11 to P14, which are the second visitors, in the database as new visitors. For example, the information processing apparatus 100 issues visitor IDs to identify the persons P11 to P14 as the new visitors, and associates the issued visitor IDs with the facial images of the persons P11 to P14, to register in the database.

FIG. 1(a) illustrates an example of a database according to a registration state at step S13. The example in FIG. 1(a) illustrates an example in which the information processing apparatus 100 issues a visitor ID “VID11” to identify the person P11, and associates the facial image 111 of the person P11 with the visitor ID “VID 11”, to register in the database. The person P12, the person P13, and the person P14 are also processed as illustrated in FIG. 1(a) and, therefore, explanation thereof will be omitted.

The persons P11 to P14 have got a track record of having visited the store FC1 by being newly recorded as illustrated in FIG. 1(a). Therefore, in the future determination processing by the information processing apparatus 100, the persons P11 to P14 will be regarded as the first visitors that has visited the store FC1. That is, in the example in FIG. 1, the first visitor signifies a person that has visited the store FC1, and has been taken a facial image. On the other hand, the second visitor signifies a person that is a subject of determination processing as the person visits the store FC1 and a facial image is captured, irrespective of presence or absence of a track record.

Moreover, the information processing apparatus 100 displays an acquired facial image in real time on a timeline page C21 displayed on the terminal device 10 of the user U11 each time a facial image is acquired from the imaging device 30-11 (step S14). On the timeline page C21, the facial images are displayed in real time chronologically according to a date and time of capture. Therefore, in the example in FIG. 1, the facial image #111 of the person P11, the facial image #112 of P12, the facial image #113 of P13, and the facial image #114 of the person P14 sequentially roll down in this order to be displayed on the timeline page C21. As described, the information processing apparatus 100 notifies the user U11 about a visitor to the store FC1 at all times through the timeline page C21.

Furthermore, the information processing apparatus 100 accepts settings to tag a person subject to be tracked so that the user U11 can track the person notified as a visitor for future revisits (step S15). For example, to be able to track a revisit of a concerned specific person out of persons displayed on the timeline page C21, the user U11 can tag information indicating this person with attribute information for the tracking purpose.

For example, when there is a person that the user U11 feels suspicious from a facial image, from an impression when the user U11 actually sees this person, or the like, determining that this person is of a specific attribute (for example, a suspicious individual), the user U11 can configure to tag attribute information “SUSPICIOUS INDIVIDUAL” to information about this person. In the example in FIG. 1, suppose that the user U11 has determined that the person P14 is suspicious from the facial image #111 displayed on the timeline page C21. Moreover, suppose that the user U11 has configured the information processing apparatus 100 such that a revisit of the person P14 can be tracked by tagging the attribute information “SUSPICIOUS INDIVIDUAL” to information about the person P14 according to the determination.

Having accepted an input of the attribute information “SUSPICIOUS INDIVIDUAL” as tag settings from the user U11, the information processing apparatus 100 registers the attribute information “SUSPICIOUS INDIVIDUAL” in the database so that the attribute information “SUSPICIOUS INDIVIDUAL” can be tagged to the information about the person P14 (step S16).

FIG. 1(b) illustrates an example of the database according to a registration state at step S16. In the example in FIG. 1(b), an example in which the information processing apparatus 100 associates a set of the visitor ID “VID14” to identify the person P14 and the facial image #114 of the person P14 with the attribute information “SUSPICIOUS INDIVIDUAL”.

Subsequently, an example of the information processing relating to visit notification according to the tag settings will be explained. In this example, it will be explained, supposing that the person P14 that has been determined as “SUSPICIOUS INDIVIDUAL” as a specific attribute revisits the store FC1. In such a case, the imaging device 30-11 detects a face of the person P14 as the person P14 passes through the entrance of the store FC1, and captures a facial image of the person P14 (step S21).

Next, the imaging device 30-11 transmits the captured facial image to the information processing apparatus 100 (step S22). In the example in FIG. 1, it is assumed that the imaging device 30-11 has transmitted a facial image #115 of the person P14 to the information processing apparatus 100.

Having received the facial image from the imaging device 30-11, the information processing apparatus 100 performs the same-person determination processing using an arbitrary face recognition technique (step S23). Specifically, the information processing apparatus 100 determines whether the same person as the second visitor is included among the first visitors by comparing facial images of the other persons (first visitors) that have visited the store FC1 with the facial image #115 of the person P14 (second visitor) revisiting the store FC1. That is, the information processing apparatus 100 determines whether there is one person that is common to the first visitor that has visited the store FC1 before and the second visitor visiting the store FC1 this time.

At the point of time when the determination processing at step S23 is performed, a registration state of the database of the information processing apparatus 100 is in a state illustrated in FIG. 1(b). That is, at this point, it is in a state in which the persons P11 to P14 are recognized as the first visitor that has visited the store FC1, and facial images that has already acquired (the facial images #111, #112, #113, and #114) are registered in the database. Moreover, by the tag settings by the user U11, the set of the visitor ID “VID14” to identify the person P14 as the first visitor and the facial image #114 of the person P14 is associated with the attribute information “SUSPICIOUS INDIVIDUAL”.

Therefore, the information processing apparatus 100 determines that the same person as the second visitor is present among the first visitors at the determination processing at step S23. For example, the information processing apparatus 100 recognizes that the person of the facial image #114 and the person of the facial image #115 are the same person as a result of verification between the facial image #114 and the facial image #115, and as a result, determines that the same person as the second visitor is present among the first visitors.

Furthermore, when it is thus determined that the same person is present, the information processing apparatus 100 registers the facial image of the second visitor in the database, associating with the visitor ID to identify the first visitor (hereinafter, it may be denoted as “first visitor subject of determination”) determined as the same person as the second visitor. In the example in FIG. 1, the information processing apparatus 100 registers the facial image #115 of the person P14, which is the second visitor in the database, associating with the visitor ID “VID14” to identify the first visitor subject of determination.

Moreover, in this example, the information processing apparatus 100 can determine that the attribute information corresponding to the first visitor subject of determination is the specific attribute “SUSPICIOUS INDIVIDUAL” by referring to the database. Therefore, the information processing apparatus 100 notifies the user U11 that a subject person (person P14) determined as a suspicious individual at least at the previous visit has visited again (step S24). For example, the information processing apparatus 100 may display the facial image #115 tagged with the attribute information “SUSPICIOUS INDIVIDUAL” on the terminal device 10 by tagging the attribute information “SUSPICIOUS INDIVIDUAL” to the facial image #115 of the subject person. As one example, the information processing apparatus 100 may notify that the subject person determined as a suspicious individual has visited again the store FC1 by adding the attribute information “SUSPICIOUS INDIVIDUAL” as a tag to the facial image #115 of the subject person out of facial images displayed chronologically in a list on the timeline page C21.

In the example in FIG. 1, an example in which the terminal device 10, the imaging device 30, and the information processing apparatus 100 are respectively individual devices has been shown. However, the terminal device 10, the imaging device 30, and the information processing apparatus 100 may be combined appropriately. For example, the terminal device 10 and the imaging device 30 may be configured as a single device. In this case, it is assumed that, for example, a person visiting the store FC1 takes his/her face by himself/herself with the terminal device 10, and transmits a facial image taken by himself/herself to the information processing apparatus 100.

Furthermore, for example, the imaging device 30 and the information processing apparatus 100 may be configured as a single device. In this case, the imaging device 30 may have all or some of functions of the information processing apparatus 100, and the determination processing and the like explained in FIG. 1 may thereby be performed by the imaging device 30.

### 3. APPLICABLE SCENE

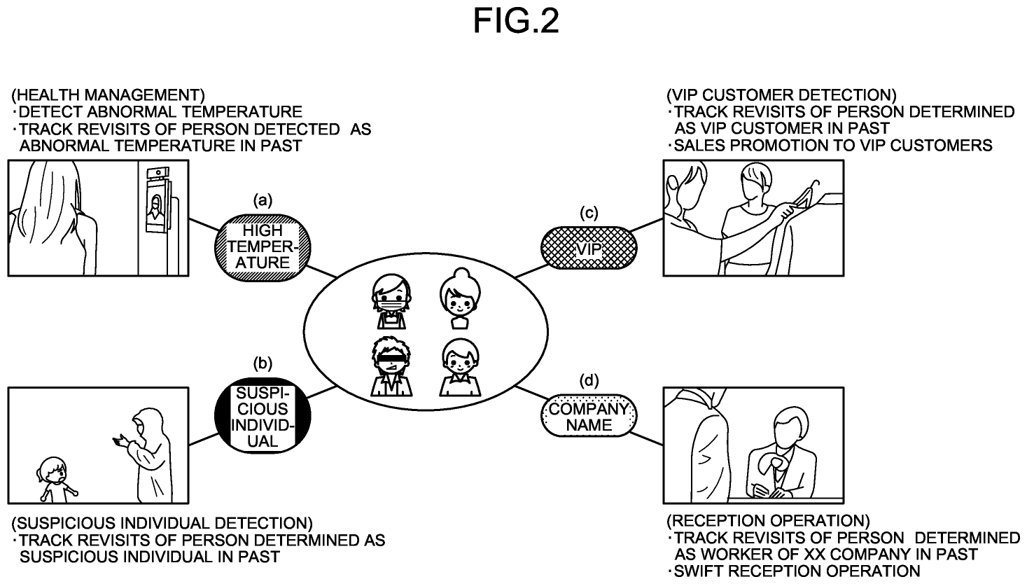

Next, a scene to which the information processing according to the embodiment is applicable as a service will be explained by using FIG. 2. FIG. 2 is a diagram illustrating an example of a scene to which the information processing according to the embodiment is applicable as a service.

According to FIG. 2(a), the information processing according to the embodiment can be applied as a service relating to health management of visitors. In this service, the imaging device 30 detects a body temperature of a visitor. Moreover, when it is recognized that a visitor has an abnormal temperature (for example, 37.5° C. or higher) from a detected body temperature, the information processing apparatus 100 dynamically adds attribute information “ABNORMAL TEMPERATURE” to information indicating this visitor, and thereby displays, for example, a facial image of the visitor to which the attribute information “ABNORMAL TEMPERATURE” is tagged on the terminal device 10. Thus, the user becomes possible to track the visitor that has determined to have an abnormal temperature and, therefore, can take measures of infectious diseases in the facility effectively, for example. Note that the abnormal temperature signifies an abnormal body temperature.

Furthermore, according to FIG. 2(b), the information processing according to the embodiment can be applied as a service relating to detection of a suspicious individual. As explained in FIG. 1, in this service, the imaging device 30 captures a facial image of a visitor. Moreover, the information processing apparatus 100 notifies of a visit of a person by using the captured facial image, and accepts settings to add attribute information indicating this specific attribute as a tag to the person that has been determined to be of the specific attribute (in this example, suspicious individual). Thus, the user becomes possible to track the visitor determined as a suspicious individual by the user himself/herself and, therefore, can take, for example, anti-crime measures in the facility effectively.

Furthermore, according to FIG. 2(c), the information processing according to the embodiment can be applied as a service relating to detection of a VIP customer. In this service, the imaging device 30 captures a facial image of a visitor. Moreover, the information processing apparatus 100 notifies of a visit of a person by using the captured facial image, and accepts settings to add attribute information indicating this specific attribute as a tag to the person that has been determined to be of the specific attribute (in this example, VIP). Thus, the user becomes possible to track the visitor determined as a VIP by the user himself/herself and, therefore, can perform, for example, an appropriate sales activity according to each customer.

Furthermore, according to FIG. 2(d), the information processing according to the embodiment can be applied as a service relating to visits from a business acquaintance. In this service, the imaging device 30 captures a facial image of a visitor. Moreover, the information processing apparatus 100 notifies of a visit of a person by using the captured facial image, and accepts settings to add attribute information indicating this specific attribute as a tag to the person that has been determined to be of the specific attribute (in this example, Mr./Ms. xx of yy company). Thus, the user becomes possible to track a visit from a specific company and, therefore, becomes possible to perform reception operation swiftly.

### 4. CONFIGURATION OF INFORMATION PROCESSING APPARATUS

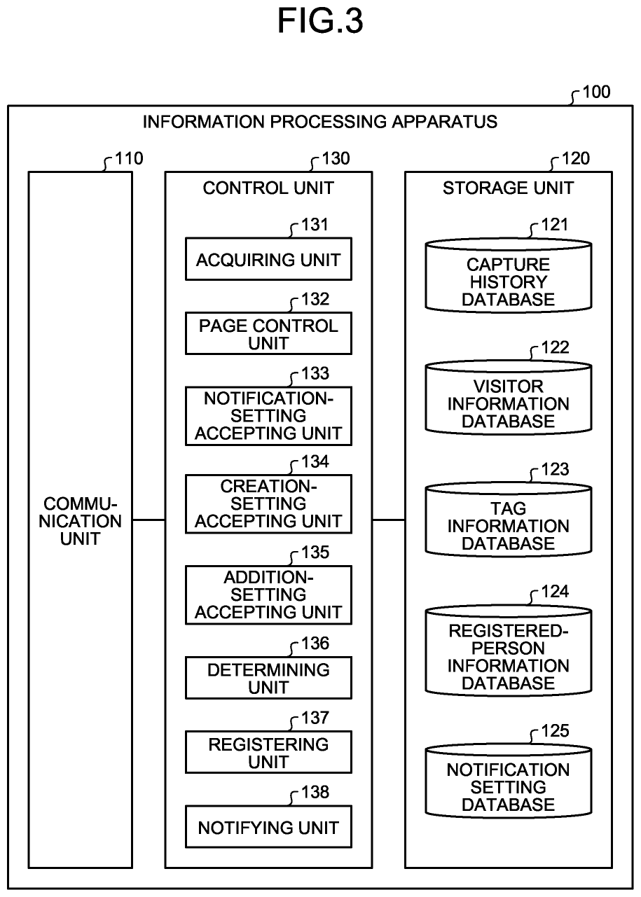

Next, the information processing apparatus 100 according to the embodiment will be explained by using FIG. 3. FIG. 3 is a diagram illustrating a configuration example of the information processing apparatus 100 according to the embodiment. As illustrated in FIG. 3, the information processing apparatus 100 includes a communication unit 110, a storage unit 120, and a control unit 130.

### Communication Unit 110

The communication unit 110 is implemented by, for example, a network interface card (NIC) or the like. The communication unit 110 is connected wiredly or wirelessly to a network, and performs transmission and reception of information, for example, with the terminal device 10 or the imaging device 30.

### Storage Unit 120

The storage unit 120 is implemented by, for example, a semiconductor memory device, such as a random access memory (RAM) and a flash memory, or a storage device, such as a hard disk and an optical disk. The storage unit 120 includes a capture history database 121, a visitor information database 122, a tag information database 123, a registered-person information database 124, and a notification setting database 125.

### Capture History Database 121

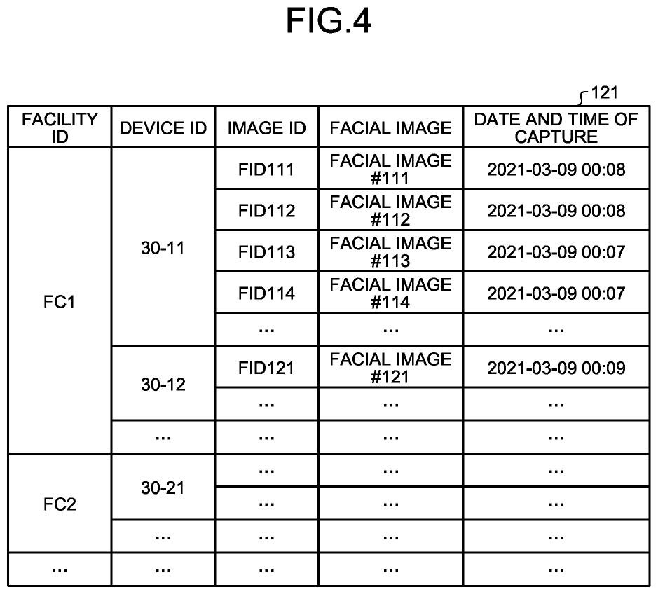

The capture history database 121 stores history information relating to capture of a facial image. FIG. 4 illustrates an example of the capture history database 121 according to the embodiment.

In the example in FIG. 4, the capture history database 121 has items of “FACILITY ID (identifier)”, “DEVICE ID (identifier)”, “IMAGE ID (identifier)”, “FACIAL IMAGE”, and “DATE AND TIME OF CAPTURE”.

“FACILITY ID (identifier)” indicates identification information to identify a facility to be a predetermined place to be visited. Moreover, the facility herein may be, for example, a store, company, or the like. “DEVICE ID (identifier)” indicates identification information to identify the imaging device 30 that is installed in the facility identified by the “FACILITY ID”.

FIG. 4 illustrates an example in which the facility ID “FC1” and the device ID “30-11” are associated with each other. This example corresponds to the example in FIG. 1, and illustrates an example in which the imaging device 30-11 is arranged at the entrance of the store FC1. The number of imaging device 30 to be installed in the facility is not limited, and may be decided arbitrarily, for example, by an administrator of the facility.

“IMAGE ID (identifier)” indicates identification information to identify “FACIAL IMAGE”. For example, “FACIAL ID” may be issued by the information processing apparatus 100 when “FACIAL IMAGE” is captured. “FACIAL IMAGE” indicates facial image data that is captured by the imaging device 30 identified by “DEVICE ID” in accordance with detection of a face of a person visiting the facility identified by “FACILITY ID”. “DATE AND TIME OF CAPTURE” indicates a date and time at which “FACIAL IMAGE” is captured. “DATE AND TIME OF CAPTURE” may be a date and time when the imaging device 30 identified by “DEVICE ID” detects a face. Moreover, “DATE AND TIME OF CAPTURE” may be a date and time when the information processing apparatus 100 registers “FACIAL IMAGE” in the database. Furthermore, although not illustrated in FIG. 4, the capture history database 121 may further record “FEATURE INFORMATION” that is extracted from “CAPTURED IMAGE”. In this case, “DATE AND TIME OF CAPTURE” may be a date and time when “FEATURE INFORMATION” indicating features of a face from “CAPTURED IMAGE”.

FIG. 4 illustrates an example in which an image ID “FID111” and the facial image “FACIAL IMAGE #111”, and a date and time of capture “2021-03-09 00:08” are associated with each other. This example corresponds to the example in FIG. 1, and illustrates the example in which the imaging device 30-11 arranged at the entrance of the store FC1 performs capturing, to acquire the facial image #111, and the image ID “FID111” is issued.

As described, in the capture history database 121, each time a facial image is captured, information relating to the captured image is registered as one record indicating a capture history. Therefore, the capture history registered in the capture history database 121 may corresponds to, for example, information displayed on the timeline page C21 explained in FIG. 1.

### Visitor Information Database 122

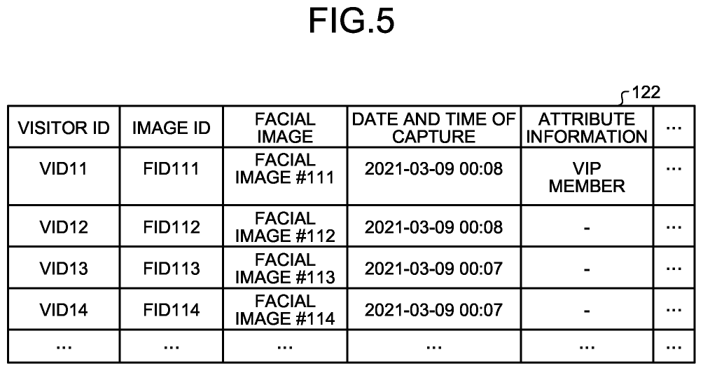

In the visitor information database 122, a person, a facial image of which is captured is managed as the first visitor. FIG. 5 illustrates an example of the visitor information database 122 according to the embodiment.

In the example in FIG. 5, the visitor information database 122 has items of “VISITOR ID (identifier)”, “IMAGE ID (identifier)”, “FACIAL IMAGE”, and “ATTRIBUTE INFORMATION”.

“VISITOR ID (identifier)” indicates identification information to identify a person, “FACIAL IMAGE” of which is captured as the person visits the facility, as the first visitor. “IMAGE ID (identifier)” indicates identification information to identify “FACIAL IMAGE”, and corresponds to “IMAGE ID” in FIG. 4. “FACIAL IMAGE” indicates facial image data of a person that is identified by “VISITOR ID”, and corresponds to “FACIAL IMAGE” of FIG. 4. “DATE AND TIME OF CAPTURE” indicates identification information to identify “FACIAL IMAGE”, and corresponds to “IMAGE ID” in FIG. 4. “DATE AND TIME OF CAPTURE” indicates a date and time when “FACIAL IMAGE” is captured, and corresponds to “DATE AND TIME OF CAPTURE”.

“ATTRIBUTE INFORMATION” is information indicating a specific attribute that is determined to be of a person identified by “VISITOR ID”. The specific attribute herein may be originally determined by a user, or may be determined dynamically by the information processing apparatus 100. For example, when it is recognized as an abnormal temperature about a person subject of detection from a body temperature detected by the imaging device 30, the information processing apparatus 100 can determine as the attribute “ABNORMAL TEMPERATURE” for the person. Moreover, for example, when it is recognized as no mask about a person of detection from a facial image detected by the imaging device 30, the information processing apparatus 100 can determine as an attribute “NO MASK” for the person.

Association of “FACIAL IMAGE” with respect to “VISITOR ID” will be explained. For example, suppose that the information processing apparatus 100 determines that the same person as the second visitor is present among the first visitors by verification between “FACIAL IMAGE” (that is, a facial image of the first visitor) that is associated with “VISITOR ID” and a facial image of the second visitor visiting this time. In this case, the information processing apparatus 100 registers “FACIAL IMAGE” of the second visitor this time in the visitor information database 122, associating with “VISITOR ID” to identify this first visitor.

On the other hand, suppose that the information processing apparatus 100 determines that the same person as the second visitor is not present among the first visitors by verification between “FACIAL IMAGE” (that is, a facial image of the first visitor) that is associated with “VISITOR ID” and a facial image of the second visitor visiting this time. In this case, the information processing apparatus 100 issues new “VISITOR ID” to identify the person, which is the second visitor, as the first visitor, and registers a facial image of the second visitor in the visitor information database 122, associating with issued “VISITOR ID” to identify this first visitor.

The determination processing explained in FIG. 5 may be performed by a determining unit 136, and the registration processing may be performed by a registering unit 137.

### Tag Information Database 123

First, when a person determined to be of a specific attribute revisits, the information processing apparatus 100 may accept settings of attribute information (second attribute information) indicating this specific attribute, which is attribute information to notify of the revisit of the person, by adding information indicating this person as a tag.

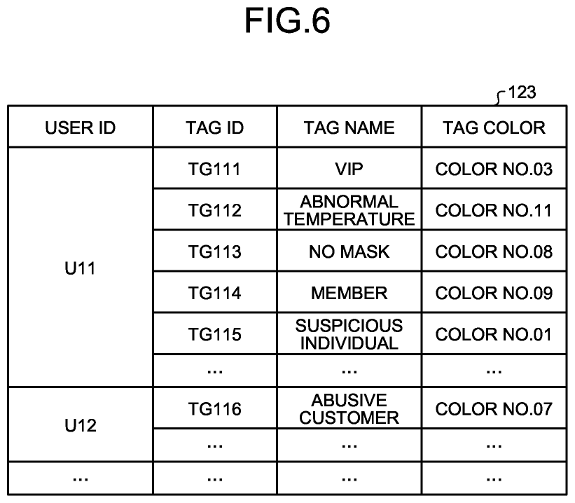

According to the information processing apparatus 100 as described, a user can create a tag indicating a specific attribute thought by himself/herself (that is, tag corresponding to the second attribute information), and can set the created tag to the information processing apparatus 100. For example, the user can create a tag through a tag creation page C13 described later. Therefore, the tag information database 123 stores information relating to a tag created by a user. FIG. 6 illustrates an example of the tag information database 123 according to the embodiment.

In the example in FIG. 6, the tag information database 123 has items of “USER ID (identification)”, “TAG ID (identifier)”, “TAG NAME”, and “TAG COLOR”.

“USER ID (identifier)” indicates identification information to identify a user (for example, user that wishes to track a visitor) of a service provided by the information processing apparatus 100. “USER ID” may be identification information to identify the terminal device 10 of the user.

“TAG ID (identifier)” indicates identification information to identify a tag created by the user that is identified by “USER ID”. “TAG NAME” is a name characterizing an attribute that can be determined by the user with respect to a visitor, and may be set to any name. For example, when one user wants to add the attribute information “SUSPICIOUS INDIVIDUAL” to a person determined as a suspicious individual as a tag, “SUSPICIOUS INDIVIDUAL” can be set as the tag name. Moreover, when another user wants to add attribute information “person to be watch out for” to a person determined as a suspicious individual as a tag, “person to be watch out for” can be set as the tag name. On the other hand, the information processing apparatus 100 may present candidates of “TAG NAME” to the user, to have him/her select appropriate “TAG NAME” from among the candidates.

“TAG COLOR” is information to identify a color when a tag identified by “TAG ID” is displayed. For example, the information processing apparatus 100 presents candidates of “TAG COLOR” TO THE USER, and can let the user select favorite “TAG COLOR” from among the candidates.

FIG. 6 illustrates an example in which the user ID “U11”, a tag ID “TG111”, a tag name “VIP”, and a tag color “color No. 03” are associated with one another. This example illustrates a case in which the user identified by the user ID “U11” creates a “VIP” tag by settings “VIP” to the tag name because the user wishes to track a person determined to be of the attribute “VIP”. Moreover, this example illustrates a case in which the user U11 configures such that the VIP″ tag is displayed in color identified by “COLOR No. 03”. Furthermore, the example illustrates a case in which information set by the user U11 is managed with the tag ID “TG111”.

### Registered-Person Information Database 124

Moreover, the information processing apparatus 100 may further accept designation of a subject of tagging, which is a person to be tagged with the tag (tag corresponding to the second attribute information) created by the user. Furthermore, when a subject to be tagged is designated, the information processing apparatus 100 registers a facial image of the designated subject to be tagged out of facial images of persons registered as the first visitor in the registered-person information database 124, associating with a tag.

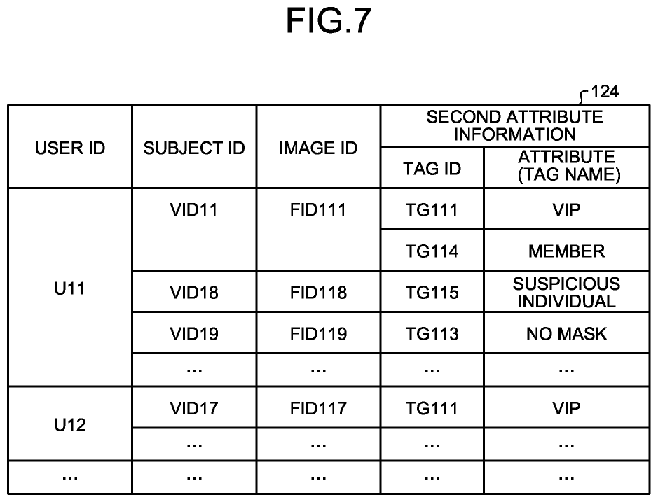

FIG. 7 illustrates an example of the registered-person information database 124 according to the embodiment. In the example in FIG. 7, the registered-person information database 124 has items of “USER ID (identifier)”, “SUBJECT ID (identifier)”, “IMAGE ID (identifier)”, and “SECOND ATTRIBUTE INFORMATION”. Furthermore, “SECOND ATTRIBUTE INFORMATION” has items of “TAG ID (identifier)” and “TAG NAME”.

“USER ID (identifier)” indicates identification information to identify a user of a service provided by the information processing apparatus 100, and corresponds to “USER ID” in FIG. 6. “SUBJECT ID (identifier)” indicates information to identify a person designated by the user as the subject to be tagged out of persons managed as the first visitor in the visitor information database 122. May be identification information to identify the terminal device 10 of the user. Moreover, because of this situation, “VISITOR ID” in FIG. 5 may be used as “SUBJECT ID”.

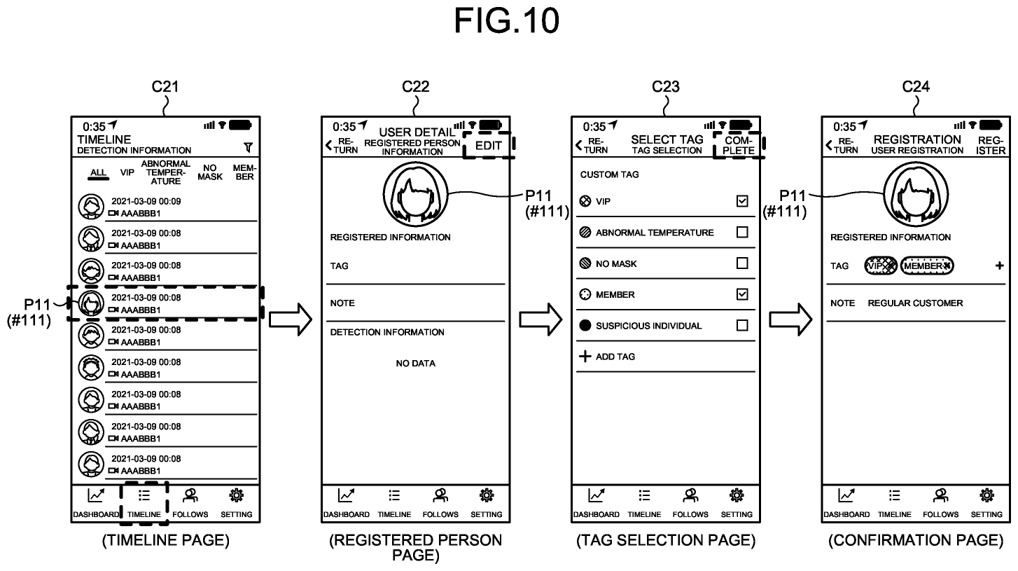

“IMAGE ID (identifier)” indicates identification information to identify a facial image of a person that is identified by “SUBJECT ID”, and that is registered as the first visitor. Moreover, although it will be explained in FIG. 10 later, the user can select an arbitrary facial image from among facial images displayed in a list on the timeline page C21, and set the person of the selected facial image as the subject to be tagged. Therefore, “IMAGE ID” herein may be identification information to identify a facial image selected from among facial images displayed in a list on the timeline page C21 to designate the subject to be tagged. Furthermore, because of this situation, “IMAGE ID” in FIG. 4 may be used as “IMAGE ID”.

“SECOND ATTRIBUTE” is attribute information indicating an attribute determined, to notify of revisit of a person identified by “SUBJECT ID” by a user with respect to the person. Moreover, “SECOND ATTRIBUTE INFORMATION” may be a combination of “TAG ID” and “TAG NAME” as illustrated in FIG. 7. Moreover, in such a case, “TAG ID” is identification information to identify a tag corresponding to an attribute determined with respect to a person identified by “SUBJECT ID” out of tags created by the user. From such a situation, “TAG NAME” is a name characterizing an attribute determined with respect to the person identified by “SUBJECT ID”.

FIG. 7 illustrates an example in which the user ID “U11”, a subject ID “VID11”, an image ID “FID111”, the tag ID “TG111”, and the tag name “VIP” are associated with one another. This example illustrates a case in which the user U11 designates, as the user U11 determines a person identified by the subject ID “VID11” to be of the specific attribute “VIP”, the person as the subject to be tagged because the user U11 wishes to track revisits of the person. Moreover, when the person identified by the subject ID “VID11” revisits, the user U11 configures notification settings such that a revisit is notified by using the tag identified by the tag ID “TG111” and the tag name “VIP”. Furthermore, in response to the notification settings described above, the information processing apparatus 100 can register the attribute information “VIP” with respect to a set of the visitor ID “VID11” and the image ID “FID111” as illustrated in FIG. 5.

### Notification Setting Database 125

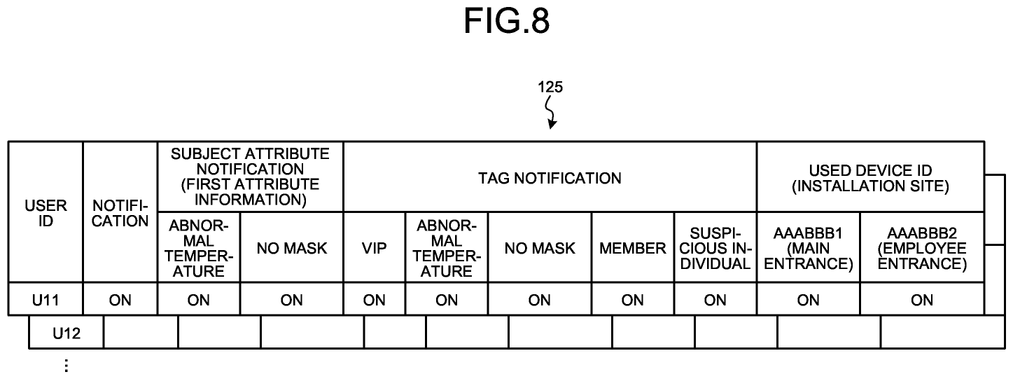

The information processing apparatus 100 can further accept settings (notification settings) relating to notification control according to the tag created by the user. According to the information processing apparatus 100 as described, for example, the user can set ON/OFF of notification by using a tag created by himself/herself. For example, the user can configure notification settings through the notification setting page C31 described later. Accordingly, the notification setting database 125 stores information relating to notification settings by a user. FIG. 8 illustrates an example of the notification setting database 125 according to the embodiment.

In the example in FIG. 8, the notification setting database 125 has items of “USER ID (identifier)”, “NOTIFICATION”, “SUBJECT ATTRIBUTE NOTIFICATION”, “TAG NOTIFICATION”, and “USED DEVICE ID (identifier)”.

“USER ID (identifier)” indicates identification information to identify a user of a service provided by the information processing apparatus 100, and corresponds to “USER ID” in FIG. 6 and FIG. 7.

“NOTIFICATION” is information indicating a switching state switched between ON/OFF of visit notification by a user. For example, the user can configure ON/OFF of the visit notification by using a switching switch SW3 of the notification setting page C31. For example, when the switching switch SW3 is switched to ON according to an operation made by the user, notification “ON” is registered as in the example of FIG. 8.

The information processing apparatus 100 may further accept settings of attribute information (first attribute information) indicating a specific attribute, which is the attribute information for performing visit notification each time a person of the specific attribute visits. Furthermore, a subject attribute to be a subject of the first attribute information may be an attribute for measures of infectious diseases. As the attribute for measures of infectious diseases, for example, “ABNORMAL TEMPERATURE” based on a body temperature of 37.5° C. or higher, or “NO MASK” are included.

For example, the user can notify that a person of “ABNORMAL TEMPERATURE” visits by using a checkbox CB321 on the notification setting page C31. For example, when a check mark is entered in the checkbox CB321 according to an operation made by the user, abnormal temperature “ON” is registered as in the example of FIG. 8. Moreover, in a state in which the abnormal temperature “ON” is registered, the information processing apparatus 100 notifies that the person of the attribute “ABNORMAL TEMPERATURE” has visited, regardless of whether this visitor is included in the first visitors.

Furthermore, for example, the user can notify that a persons of “NO MASK” has visited by using a checkbox CB322 of the notification setting page C31. For example, when a check mark is entered in the checkbox CB322 according to an operation made by a user, no mask “ON” is registered as the example of FIG. 8. Moreover, in a state in which no mask “ON” is registered, the information processing apparatus 100 notifies that the person of the attribute “NO MASK” has visited, regardless of whether this visitor is included in the first visitors.

“TAG NOTIFICATION” indicates a setting state in which whether a revisit is notified is set when a person tagged with a tag created by the user revisits. Moreover, from such a situation, items included in “TAG NOTIFICATION” can vary. For example, in the example in FIG. 8, a case in which “TAG NOTIFICATION” corresponding to the user ID “U11” includes “VIP”, “ABNORMAL TEMPERATURE”, “NO MASK”, “MEMBER”, AND “SUSPICIOUS INDIVIDUAL” is illustrated. This example corresponds to the example in FIG. 6, and is equivalent to creation of the “VIP” tag, the “ABNORMAL TEMPERATURE” tag, the “NO MASK” tag, the “MEMBER” tag, and the “SUSPICIOUS INDIVIDUAL” tag by the user U11. Furthermore, according to this example, the user U11 can notify a revisit of the person tagged with “VIP” tag by using a checkbox CB323 of the notification setting page C31.

For example, when a check mark is entered in the checkbox CB323 according to an operation made by a user U11, VIP “ON” is registered as the example of FIG. 8. Moreover, in a state in which VIP “ON” is registered, suppose that the information processing apparatus 100 determines that the same person as the second visitor is included in the first visitors. In this case, the information processing apparatus 100 notifies that the person that has determined as the attribute “VIP” at a past visit has visited again as the second visitor to the user U11, if the attribute information (second attribute information) corresponding to the first visitor indicates “VIP”.

“USED DEVICE ID (identifier)” indicates identification information to identify the imaging device 30 to be used, determining a facial image captured by which one of the imaging device 30 out of the imaging devices 30 that is authorized to manage by the user identified by “USER ID” is to be used for notification. Moreover, from this situation, contents of “USED DEVICE ID” can vary depending on a user. For example, in the example in FIG. 8, a case in which “USED DEVICE ID” corresponding to the user ID “U11” is “AAABBB1” and “AAABBB2” is illustrated. This example shows a case in which the user U11 is authorized to manage the imaging device 30 identified by “AAABBB1” and the imaging device 30 identified by “AAABBB2”.

Furthermore, the user U11 can set whether to make the imaging device 30 identified by “AAABBB1” be a subject to be used, by using a checkbox CB328 on the notification setting page C31. For example, when a check mark is entered in the checkbox CB328 according to an operation made by the user, AAABBB1 “ON” is registered as in the example of FIG. 8. In a state in which AAABBB1 “ON” is registered, the information processing apparatus 100 performs determination processing based on a facial image captured by the imaging device 30 identified by “AAABBB1”, and uses the facial image captured by the imaging device 30 identified by “AAABBB1” for the visit notification.

Moreover, the user U11 can set whether to make the imaging device 30 identified by “AAABBB2” be a subject to be used, by using a checkbox CB329 on the notification setting page C31. For example, when a check mark is entered in the checkbox CB329 according to an operation made by the user U11, AAABBB2 “ON” is registered as in the example of FIG. 8. In a state in which AAABBB2 “ON” is registered, the information processing apparatus 100 performs determination processing based on a facial image captured by the imaging device 30 identified by “AAABBB2”, and uses the facial image captured by the imaging device 30 identified by “AAABBB1” for the visit notification.

### Control Unit 130

Referring back to FIG. 3, the control unit 130 is implemented by various kinds of programs (for example, the information processing program according to the embodiment) stored in a storage device in the information processing apparatus 100 being executed by a central processing unit (CPU), a micro processing unit (MPU), or the like, by using the RAM as a work area. Moreover, the control unit 130 is implemented by an integrated circuit, such as an application specific integrated circuit (ASIC) and a field programmable gate array (FPGA).

As illustrated in FIG. 3, the control unit 130 includes an acquiring unit 131, a page control unit 132, a notification-setting accepting unit 133, a creation-setting accepting unit 134, an addition-setting accepting unit 135, a determining unit 136, a registering unit 137, and a notifying unit 138, and implements or performs functions and actions of the information processing explained below. An internal configuration of the control unit 130 is not limited to the configuration illustrated in FIG. 3, but may take other configurations as long as it is a configuration to perform the information processing described later. Moreover, a connecting relationship of the respective processing units included in the control unit 130 is not limited to the connecting relationship illustrated in FIG. 3, and may take other connecting relationships.

### Acquiring Unit 131

The acquiring unit 131 acquires predetermined information to be used for the information processing according to the embodiment. For example, the acquiring unit 131 acquires a facial image. For example, when a facial image of a visitor is captured by the imaging device 30, the acquiring unit 131 acquires the captured facial image. Moreover, the acquiring unit 131 can register the facial image acquired from the imaging device 30 in the capture history database 121.

Furthermore, having acquired a facial image from the imaging device 30, the acquiring unit 131 acquires a facial image of the first visitor also so that the determination processing using the facial image of the second visitor, which is the acquired facial image, is performed by the determining unit 136. For example, the acquiring unit 131 acquires a facial image of the first visitor from the visitor information database 122.

Moreover, the acquiring unit 131 acquires attribute information indicating an attribute of the first visitor at the time of visit also so that the determination processing is performed by the determining unit 136. For example, the acquiring unit 131 may acquire the attribute information indicating an attribute of the first visitor at the time of visit from the visitor information database 122.

### Page Control Unit 132

The page control unit 132 controls various kinds of pages provided to a user. For example, the page control unit 132 controls, according to an access from a user, information of a display subject that is to be displayed on a page corresponding to the access. Moreover, the page control unit 132 controls display such that controlled information of a display subject is displayed on a page corresponding to the access.

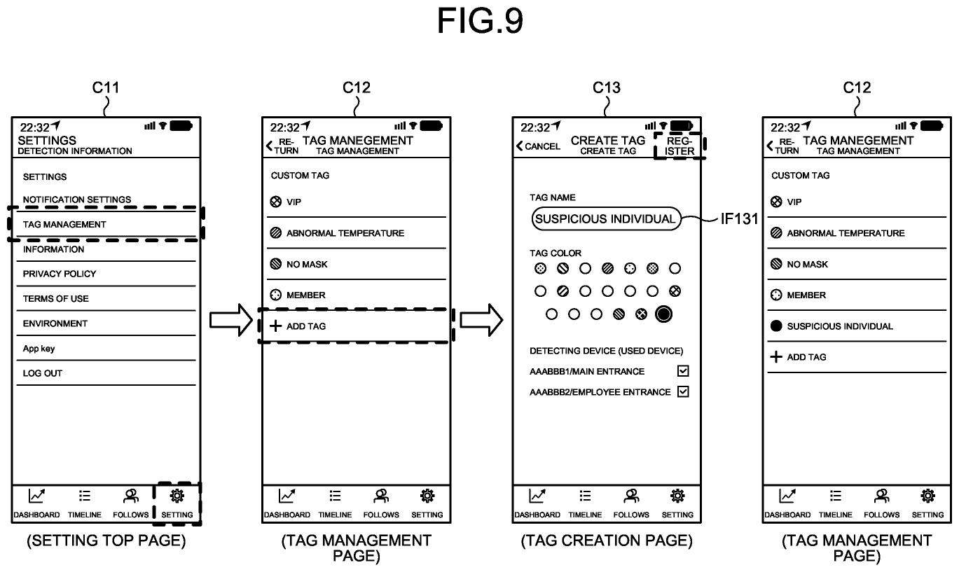

Moreover, the page control unit 132 provides a page corresponding to an access, in response to the access by the user. For example, the page control unit 132 can provide various kinds of pages explained in FIG. 9 to FIG. 14 to a user. The page that can be provided by the page control unit 132 to the user is, of course, not limited to the pages illustrated in FIG. 9 to FIG. 14.

### Notification-Setting Accepting Unit 133

The notification-setting accepting unit 133 accepts information settings relating to a notification mode for the notifying unit 138 from a user. For example, the notification-setting accepting unit 133 accepts attribute information of a notification subject that indicates when a person of what kind of attribute visits, the visit is to be notified to the user.

For example, the notification-setting accepting unit 133 accepts the first attribute information that is attribute information to notify of a visit each time when a person of a specific attribute visits, and that indicates this specific attribute, as attribute information of a notification subject. The attributes indicated by the first attribute information include an attribute for measures of infectious diseases. Furthermore, the attribute for measures of infectious diseases includes “ABNORMAL TEMPERATURE” based on a body temperature of 37.5° C. or higher, or “NO MASK” are included.

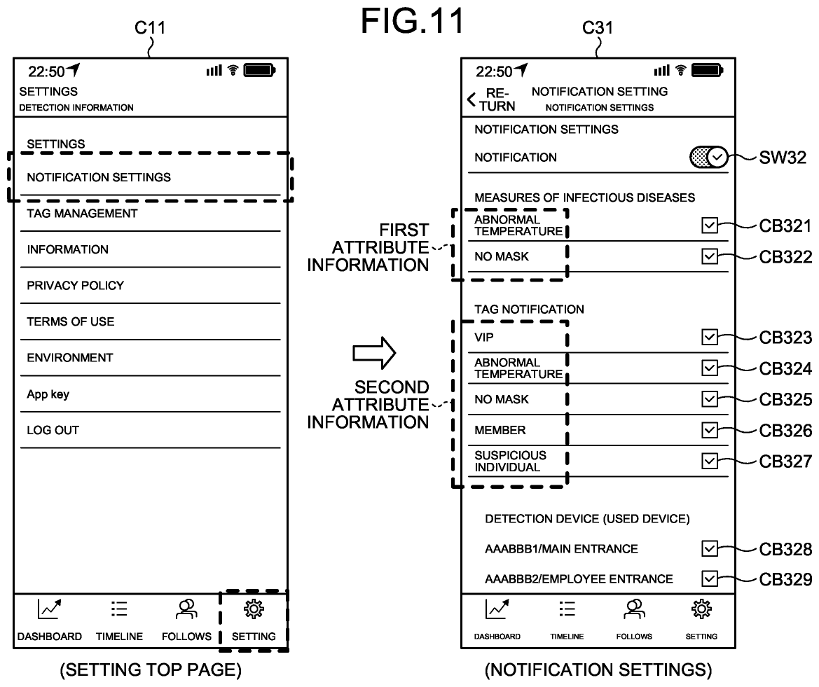

Moreover, the notification-setting accepting unit 133 can accept settings of the first attribute through the notification setting page C31 illustrated in FIG. 11. Furthermore, in a state in which the first attribute information is accepted as the attribute information of a notification subject, the notifying unit 138 notifies, when the visitor is recognized as the attribute indicated by the first attribute information (for example, “ABNORMAL TEMPERATURE”), that a person of the attribute indicated by the first attribute information (for example, “ABNORMAL TEMPERATURE”) has visited, regardless of whether this visitor is included among the first visitors.

Moreover, the notification-setting accepting unit 133 accepts the second attribute information, which is attribute information to notify that a person of a specific attribute has visited again, and that indicates the specific attribute, as a notification subject.

Furthermore, the notification-setting accepting unit 133 can accept settings of the second attribute information through the notification setting page C31 illustrated in FIG. 11. Moreover, suppose that in a state in which the second attribute information is accepted as the attribute information of a notification subject, the determining unit 136 has determined that the same person as the second visitor is included among the first visitors. In such a case, the notifying unit 138 notifies, when the attribute information associated with this first visitor is the second attribute information, that a subject person, the attribute of which indicated by the second attribute at the time of a past visit has visited again as the second visitor.

The notification-setting accepting unit 133 may further accept designation of the imaging device 30 to be used, indicating which one of the imaging devices 30 out of the imaging devices 30 associated with the user is to be a subject of the visit notification. For example, the notification-setting accepting unit 133 can accept designation of the imaging device 30 to be used through the notification setting page C31 illustrated in FIG. 11.

Moreover, the notification-setting accepting unit 133 may perform registration to the notification setting database 125 based on the settings accepted from the user.

### Creation-Setting Accepting Unit 134

As described above, a user can create a tag indicating a specific attribute thought by the user himself/herself (that is a tag corresponding to the second attribute information), and can set the created tag in the information processing apparatus 100. That is, the creation-setting accepting unit 134 accepts information settings relating to creation of a tag. For example, the creation-setting accepting unit 134 accepts information settings relating to creation of a tag so that the user can create a tag indicating a specific attribute (that is, a tag corresponding to the second attribute information). For example, the creation-setting accepting unit 134 can accept information settings relating to creation of a tag through the tag creation page C13. For example, the creation-setting accepting unit 134 can accept settings of a tag name or selection of a tag color through the tag creation page C13.

Moreover, the creation-setting accepting unit 134 may perform registration to the tag information database 123 based on the settings accepted from the user.

### Addition-Setting Accepting Unit 135

The addition-setting accepting unit 135 accepts designation of a subject to be tagged with the second attribute out of visitors that have visited a predetermined place to be visited. Moreover, when a subject to be tagged is designated, the addition-setting accepting unit 135 stores the second attribute information as attribute information indicating an attribute at the time of visit of the first visitor, associating with a facial image of the subject to be tagged. For example, when a subject to be tagged is designated, the addition-setting accepting unit 135 registers a facial image of the designated subject to be tagged out of facial images of persons registered as the first visitor to the registered-person information database 124, associating with the second attribute as the tag.

The addition-setting accepting unit 135 can accept, when an arbitrary facial image is selected from among facial images displayed in a list on the timeline page C21, registration settings of a subject to be tagged through a registered person page C22 in which a person of the selected facial image is displayed as the subject to be tagged.

Furthermore, the addition-setting accepting unit 135 may cancel addition of this second attribute information when predetermined time has passed since the second attribute information is added to the subject to be tag as a tag.

### Determining Unit 136

The determining unit 136 determines whether the same person as the second visitor is included among the first visitors when the second visitor visits the predetermined place to be visited by verification between a facial image of the first visitor that has visited the place to be visited and a facial image of the second visitor. For example, the determining unit 136 determines whether the same person as the second visitor is included among the first visitors by verifying a facial image of the second visitor and a facial image of the first visitor each time a facial image of each of the second visitor is captured, in real time.

For example, the determining unit 136 may determine whether the same person as the second visitor is included among the first visitors by using an arbitrary face recognition technique. Furthermore, for more specific example of verification between a facial image of the first visitor and a facial image of the second visitor, the determining unit 136 may calculate a similarity of faces between the first visitor and the second visitor by comparing feature information extracted from the facial image of the first visitor and feature information extracted from the facial image of the second visitor. The determining unit 136 may determine whether the same person as the second visitor is included among the first visitors based on the calculated similarity. The “feature information” used herein may be registered, for example, in the capture history database 121.

### Registering Unit 137

The registering unit 137 performs information registration to the visitor information database 122 according to a determination result of the determining unit 136.

For example, when it is determined that the same person as the second visitor is included among the first visitors, the registering unit 17 registers the facial image of the second visitor, associating with identification information to identify the first visitor that has been determined as the same person as the second visitor, in the visitor information database 122.

On the other hand, the registering unit 137 issues identification information to identify the second visitor as a new visitor when it is determined that the same person as the second visitor is not included among the first visitors, and registers the facial image of the second visitor, associating with the issued identification information in the visitor information database 122.

When it is recognized that the visitor is of a specific attribute from a detection result detected by the imaging device 30 installed in a predetermined place to be visited with respect to a visitor, the registering unit 137 may register attribute information indicating the specific attribute in the visitor information database 122, associating with identification information. For a specific example, when it has been recognized that a visitor has an abnormal temperature from a body temperature detected by the imaging device 30 from the visitor, the registering unit 137 registers attribute information indicating an abnormal temperature in the visitor information database 122, associating with identification information. Moreover, when it has been recognized that the visitor has no mask from a face detected by the imaging device 30 from the visitor, the registering unit 137 registers attribute information indicating no mask in the visitor information database 122, associating with identification information.

### Notifying Unit 138

When attribute information corresponding to the first visitor that has been determined as the same person as the second visitor indicates a specific attribute, the notifying unit 138 notifies that a subject person, an attribute of which is the specific attribute at least at a past visit has visited again this time as the second visitor.

For example, when it is determined that the same person as the second visitor is included among the first visitors, the notifying unit 138 notifies that a subject person has visited again on a timeline page that is a page on which facial images of the second visitors are chronologically displayed in real time according to a date and time of capture. Specifically, the notifying unit 138 notifies that a subject person has visited again by tagging the attribute information indicating the specific attribute to a facial image of the subject person out of facial images of the second visitors displayed chronologically in a list on the timeline page.

### 5. SPECIFIC EXAMPLE OF INFORMATION PROCESSING

Subsequently, an example of the information processing that is performed by the processing unit explained in FIG. 3 will be explained in detail by using an example of page Control by the information processing apparatus 100. Specifically, a specific example of the information processing according to the embodiment will be described through FIG. 9 to FIG. 14. In explanation in FIG. 9 to FIG. 14, the user U1 of the store FC1 will be explained as a user that performs transmission and reception of information with the information processing apparatus 100 as an example. In the following embodiment, an expression “depress” includes a concept of various kinds of user operations indicating a selection operation, such as touch, tap, and clip.

### 5-1. Tag Creation

First, an example of the information processing to make a user perform tag creation will explained by using FIG. 9. FIG. 9 is a diagram illustrating an example of the information processing relating to tag creation. As illustrated in FIG. 9, the user U11 first accesses a settings top page C11, and by accessing various pages from the settings to page C11, enabled to configure information settings on a page of an access destination.

For example, the user U11 can access a page relating to tag creation by pressing a “TAG MANAGEMENT” button provided on the settings top page C11.

Therefore, when the “TAG MANAGEMENT” button is pressed, the page control unit 132 performs display control such that a tag management page C12 is displayed on the terminal device of the user U11. Contents displayed on the tag management page C12 may be updated according to a tag creation state at the present phase by the user U11.

On the tag management page C12 illustrated in FIG. 9, an example in which attribute information (second attribute information), such as “VIP”, “ABNORMAL TEMPERATURE”, “NO MASK”, and “MEMBER”, is displayed in a list. In this example, a case in which because the user U11 desires to be notified that a person determined as “VIP”, “ABNORMAL TEMPERATURE”, “NO MASK”, or “MEMBER” has visited again, the user U11 creates the “VIP” tag by using the attribute information “VIP”, creates the “ABNORMAL TEMPERATURE” tag by using the attribute information “ABNORMAL TEMPERATURE”, creates the “NO MASK” tag by using the attribute information “NO MASK”, and creates the “MEMBER” tag by using the attribute information “MEMBER” is illustrated.

Suppose that the user U11 desires to create another new tag in this state. In the example in FIG. 9, suppose that the user U11 desires to newly create a “SUSPICIOUS INDIVIDUAL” tag. In such a case, the user U11 presses an “ADD TAG” button provided in the tag management page C12.

When the “ADD TAG” button is pressed, the page control unit 132 controls the display such that the tag creation page C13 is displayed on the terminal device 10 of the user U11.

According to the example in FIG. 9, the tag creation page C13 may include an input field IF131 in which a tag name is input, and may include color candidates displayed in a selectable manner so that a favorite color can be applied to a tag. Moreover, as illustrated in FIG. 9, in the tag creation page C13, information about the imaging device 30 that is associated with the user U11 (management thereof is authorized to the user U11) may be displayed also.

As illustrated in FIG. 9, suppose that the user U11 inputs “SUSPICIOUS INDIVIDUAL” in the input field IF131 of the tag creation page C13, and presses the “REGISTRATION BUTTON” in an upper portion of the page while selecting the tag color “BLACK”. In this case, the creation-setting accepting unit 134 issues a tag ID “TG115” to identify the “SUSPICIOUS INDIVIDUAL” tag constituted of the tag name “SUSPICIOUS INDIVIDUAL” and the tag color “BLACK”. The creation-setting accepting unit 134 associates the tag name “SUSPICIOUS INDIVIDUAL” and a color number “01” indicating the tag color “BLACK” with a set of the user ID “U11” and the tag ID “TG115”, to register in the tag information database 123. This example corresponds to the example of the tag information database 123 illustrated in FIG. 6.

At this point, creation of the “SUSPICIOUS INDIVIDUAL” tag by the user U11 is completed. For example, when the “REGISTRATION BUTTON” is pressed as notification of completion of tag creation, the page control unit 132 may display the tag management page C12 again in which the black “SUSPICIOUS INDIVIDUAL” tag is newly added as illustrated in FIG. 9.

### 5-2. Tag Addition

Next, an example of information processing to actually add a created tag to a subject will be explained by using FIG. 10. FIG. 10 is a diagram illustrating an example of the information processing according to tag addition.

To perform tagging, the user U11 first designates a subject to be tagged. For example, the user U11 can select an arbitrary facial image from among facial images displayed in a list on the timeline page C21, and can designate a person of the selected facial image as a subject to be tagged.

In the timeline page C21 illustrated in FIG. 10, persons captured by the imaging device 30-11 installed in the store FC1 are sequentially displayed in real time as facial image of the persons are rolled down. According to the timeline page C21 as described, a facial image displayed above is a newer facial image, a date of capture of which is latest.

In such a state, suppose that the user U11 determines that the person P11 is “VIP” and “MEMBER” out of persons, facial images of which are displayed on the timeline page C21. Moreover, suppose that the user U11 desires to add the VIP″ tag corresponding to the attribute information “VIP” and the “MEMBER” tag corresponding to the attribute information “MEMBER” to the person P11 according to the determination. In this case, the user U11 first selects a facial image of the person P11 out of the facial images displayed in list on the timeline page C21. In the example in FIG. 10, suppose that the user U11 selects the facial image #111 as the facial image of the person P11.

Based on the example in FIG. 1, the information processing apparatus 100 has determined that the same person as the person P11 is not included in persons as the first visitors at this point as a result of verification between a facial image of each of the first visitors registered in the visitor information database 122 and the facial image #111 of the person P11 that is the second visitor. Moreover, according to the determination result, the information processing apparatus 100 issues the visitor ID “VID11” to newly identify the person P1 as the first visitor, and associates the facial image #111 of the person P11 with the issued visitor ID “VID11”, to register in the visitor information database 122.

Returning back to explanation of FIG. 10, the page control unit 132 controls the display such that the registered person page C22 is displayed on the terminal device 10 of the user U11 in response to selection of the facial image #111. In the example in FIG. 10, in the registered person page C22, a current registration state of the person P11 is displayed. At this point, the user U11 has not tagged the person P11, and has not registered other information either. Therefore, in the registered person page C22 illustrated in FIG. 10, a TAG field and a NOTE field are empty, and only the facial image #111 is displayed regarding the person P11 as a subject to be tagged.

Suppose that the user U11 presses a “EDIT” button in an upper portion of the page to add a tag to the person P11. The page control unit 132 then controls the display such that a tag selection page C23 is displayed on the terminal device 10 of the user U11. In the example in FIG. 10, in the tag selection page C23, a tag that has been created by the user U11 is displayed. For example, as the example in FIG. 6, when the “VIP” tag, the “ABNORMAL TEMPERATURE” tag, the “NO MASK” tag, the “MEMBER” tag, and the “SUSPICIOUS INDIVIDUAL” tag have been created by the user U11, corresponding to this example, these tags are displayed in a list in the tag selection page C23 in a list. Furthermore, in the tag selection page C23, checkboxes are provided corresponding to the respective tags such that an arbitrary tag can be selected from among the created tags.

Suppose that the user U11 inputs check marks in the checkbox of the “VIP” tag and the checkbox of the “MEMBER” tag in the tag selection page C23 as illustrated in FIG. 10, and presses a “COMPLETE BUTTON” in an upper portion of the page. In this case, the addition-setting accepting unit 135 associates the tag ID “TG111” and the tag name “VIP” with a set of the user ID “U11”, the subject ID “VID11”, and the image ID “FID111”, to register in the registered-person information database 124. Moreover, the addition-setting accepting unit 135 associates the image ID “FID111”, the tag ID “TG114”, and the tag name “MEMBER” with the user ID “U11”, the subject ID “VID11”, and the image ID “FID111”, to register in the registered-person information database 124.

At this point, addition of the “VIP” tag and the “MEMBER” tag to the person P11 that is the subject to be tagged is completed.

Furthermore, the page control unit 132 controls the display such that a confirmation page C24 is displayed on the terminal device 10 of the user U11 upon completion of addition of the “VIP” tag and the “MEMBER” tag. As illustrated in FIG. 10, in the confirmation page C24, an indication that the “VIP” tag and the “MEMBER” tag are added to the person P11 is shown. Specifically, in the TAG field of the confirmation page C24, the “VIP” tag and the “MEMBER” tag are displayed. Moreover, in the example of the confirmation page C24 illustrated in FIG. 10, text “REGULAR CUSTOMER” is input in the NOTE field by the user U11.

### 5-3. Notification Settings

Next, an example of information processing to accept settings relating to notification control (notification settings) will be explained by using FIG. 11. FIG. 11 is a diagram illustrating an example of the information processing relating to the notification settings.

The user U11 can access a page relating to the notification settings by pressing a “NOTIFICATION SETTINGS” button provided in the settings top page C11.

Therefore, the page control unit 132 controls the display such that the notification setting page C31 is displayed on the terminal device 10 of the user U11 when the “NOTIFICATION SETTINGS” button is pressed. Contents displayed in the notification setting page C31 may be updated according to a tag creation state at the present phase by the user U11.

As illustrated in FIG. 11, the notification setting page C31 may include a switching switch SW32 to switch ON/OFF of visit notification.

Moreover, as illustrated in FIG. 11, the notification setting page C31 may include the checkboxes CB321 and CB322 to accept settings of attribute information that is to make visit notification each time a person of a specific attribute visits, and that indicates this specific attribute (first attribute information), as attribute information of a notification subject. The first attribute information may be the attribute “ABNORMAL TEMPERATURE” for measures of infectious diseases, and when it is wished to be notified of a visit of a person of “ABNORMAL TEMPERATURE”, a check mark is input in the checkbox CB321. As another example, the first attribute information maybe the attribute “NO MASK” for measure of infectious diseases, and when it is wished to be notified of a visit of a person of “NO MASK”, a check mark is input in the checkbox CB322.

Furthermore, as illustrated in FIG. 11, the notification setting page C31 may include a checkbox to accept attribute information that is to notify of a revisit of a person of a specific attribute, and that indicates this specific attribute (second attribute information), as attribute information of a notification subject. That is, in the notification setting page C31, a checkbox to set whether to notify of a revisit when a person tagged with a tag created by the user U11 has visited again is included.

For example, as in the example in FIG. 6, when the user U11 has created the “VIP” tag, the “ABNORMAL TEMPERATURE” tag, the “NO MASK” tag, THE “ABNORMAL TEMPERATURE” tag, the “NO MASK” TAG, the “MEMBER” tag, and the “SUSPICIOUS INDIVIDUAL” tag, corresponding to this example, in the notification setting page C31, checkboxes corresponding to these tags are displayed in a list. Specifically, in response to creation of the “VIP” tag corresponding to the second attribute “VIP” by the user U11, as illustrated in FIG. 11, the checkbox CB323 to notify of a revisit of the person tagged with “ABNORMAL TEMPERATURE” is provided in the notification setting page C31. Moreover, in response to creation of the “ABNORMAL TEMPERATURE” tag corresponding to the second attribute “ABNORMAL TEMPERATURE” by the user U11, a checkbox CB324 to notify of a revisit of the person tagged with “ABNORMAL TEMPERATURE” is provided in the notification setting page C31. Furthermore, in response to creation of the “NO MASK” tag corresponding to the second attribute “NO MASK” by the user U11, a checkbox CB325 to notify of a revisit of the person tagged with “NO MASK” is provided in the notification setting page C31. Moreover, in response to creation of the “MEMBER” tag corresponding to the second attribute “MEMBER” by the user U11, a checkbox CB326 to notify of a revisit of the person tagged with “MEMBER” is provided in the notification setting page C31. Furthermore, in response to creation of the “SUSPICIOUS INDIVIDUAL” tag corresponding to the second attribute “SUSPICIOUS INDIVIDUAL” by the user U11, a checkbox CB327 to notify of a revisit of the person tagged with “SUSPICIOUS INDIVIDUAL” is provided in the notification setting page C31.

Moreover, as illustrated in FIG. 11, in the notification setting page C31, a checkbox to set the imaging device 30 to be used indicating a facial image captured by which one of the imaging device 30 out of the imaging devices 30 associated with the user U11 is to be used for notification may be included.

For example, suppose that the imaging devices 30 associated with the user U11 are the imaging devices 30 identified by the device ID “AAABBB1” and the device ID “AAABBB2”. In this case, as illustrated in FIG. 11, a checkbox may be displayed in the notification setting page C31 together with these device IDs. According to the example in FIG. 11, a checkbox CB328 to decide the imaging device 30 identified by the device ID “AAABBB1” as the imaging device 30 to be used is provided in the notification setting page C31. Furthermore, according to the example in FIG. 11, a checkbox CB329 to decide the imaging device 30 identified by the device ID “AAABBB2” as the imaging device 30 to be used is provided in the notification setting page C31. In the notification setting page C31, not only the device ID, but also a device name of the imaging device 30 identified by the device ID and an installation site of the imaging device 30 identified by the device ID may be displayed.

Suppose that the user U11 switched ON the switching switch SW32 as in the example in FIG. 11, and input a check mark in the respective checkboxes. In this case, the notification-setting accepting unit 133 accepts settings according to the input operation as the notification settings, to register in the notification setting database 125.

### 5-4. Confirmation of Settings

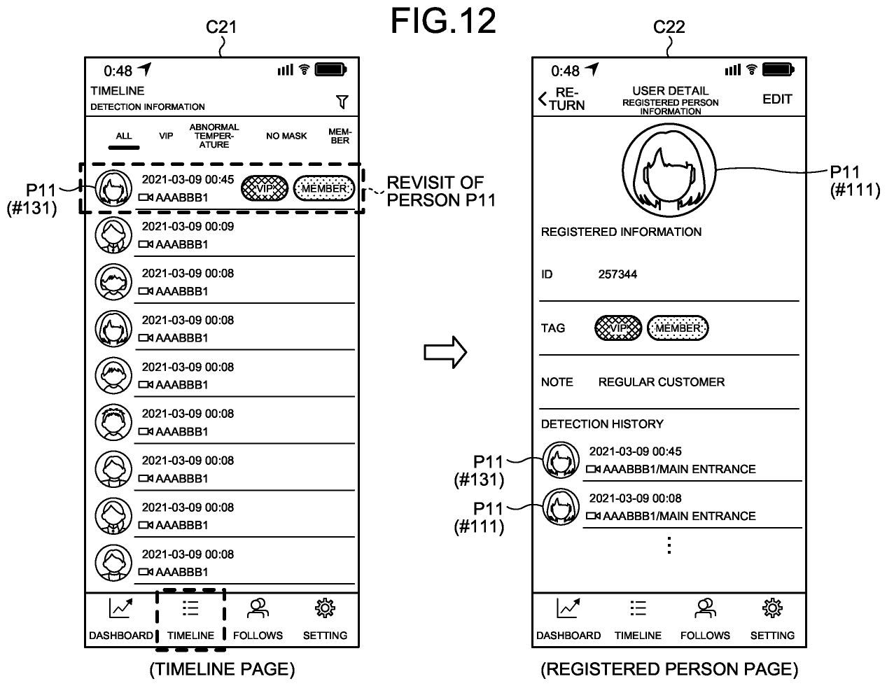

Moreover, in response to a revisit notification made as a person tagged by the user U11 himself/herself revisits, the user U11 can confirm settings (registration content) for this person. This point will be explained by using FIG. 12. FIG. 12 is a diagram illustrating an example (1) of the information processing relating to confirmation of settings.

In FIG. 12, a scene in which the user U11 confirms settings for the revisiting person P11 by using the example in the timeline page C21 when the person P11 has visited again the store FC1 is shown.

First, according to the settings so far by the user U11, the VIP″ tag and the “MEMBER” tag are added to the person P11 identified by the target ID “VID11” (FIG. 7). As a result, in the visitor information database 122, the “facial image #111”, the attribute information “VIP” and the “MEMBER” ARE ASSOCIATED WITH THE VISITOR ID “VID11” to be registered (FIG. 5). In this example, the determining unit 136 can determine that the person P11 is not a visitor visiting for the first time, but it is a revisit as a result of verification between a facial image #131 (facial image of the second visitor) captured this time from the person P11 and the facial image #111 (facial image of the first visitor).

Furthermore, the notifying unit 138 performs revisit notification in which the facial image #131 of the person P11 is displayed in the timeline page C21, in a state in which the “VIP” tag and the “MEMBER” tag are added to the facial image #131 of the person P11. The timeline page C21 illustrated in FIG. 12 corresponds to the revisit notification by the notifying unit 138, and to the facial image #131 on the top, the “VIP” tag and the “MEMBER” tag are added.

When the user U11 recognizes that the person P11 that has been determined as “VIP” and “MEMBER” by himself/herself through the timeline page C21 illustrated in FIG. 12 has visited again, the user U11 can access the registered person page C22 from the timeline page C21 to confirm the settings for the person P11. For example, the user U11 can access the registered person page C22 by selecting the facial image #131 of the person P11 to which the “VIP” tag and the “MEMBER” tag are added. For example, the page control unit 132 controls the display such that the registered person page C22 is displayed on the terminal device 10 of the user U11 when the facial image #131 of the person P11 is selected.

Furthermore, as the example in FIG. 2, for example, when accessed from the timeline page C21 for confirmation of settings, a set of a facial image of the person P11 captured before and a date and time of capture may be further displayed as a capture history (detection history) in the registered person page C22, which is the access destination. Moreover, the capture history may include the device ID to identify the imaging device 30 that has captured the facial image, or the installation site of the imaging device 30 that has captured the facial image.

### 5-5. Person Tracking

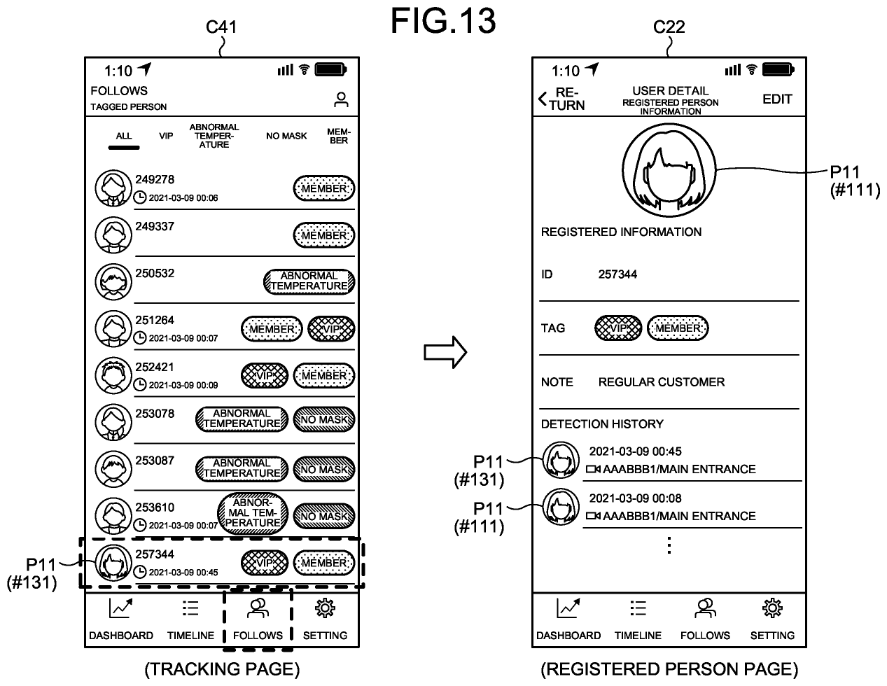

In FIG. 12, a point in which in response to revisit notification made as a tagged person revisits, the information processing is performed to confirm settings for this person has been explained. However, the information processing apparatus 100 can confirm settings for any person out of tagged persons through a tracking page in which the tagged persons are displayed in a list. This point will be explained by using FIG. 13. FIG. 13 is a diagram illustrating an example (2) of the information processing relating to confirmation of settings.

In the example in FIG. 13, the page control unit 132 controls the display such that a person tracking page C41 is displayed on the terminal device 10 of the user U11 in response to an access by the user U11. For example, the page control unit 132 extracts information relating to a person to which a tag is added by the user U11 based on the information registered in the registered-person information database 124, from the corresponding database. The page control unit 132 generates the tracking page C41 in which persons tagged by the user U11 are displayed in a list by using the extracted information, and then controls the display such that the generated tracking page C41 is displayed on the terminal device 10.

Suppose that the user U11 has selected the facial image #131 of the person 11 to which the “VIP” tag and the “MEMBER” tag are added. In this case, the page control unit 132 controls the display such that the registered person page C22 is displayed on the terminal device 10 of the user U11.

Moreover, as the example in FIG. 13, when accessed from the tracking page C41 for confirmation of settings, a set of a facial image of the person P11 captured before and a date and time of capture may be further displayed as a capture history (detection history) in the registered person page C22, which is the access destination.

Moreover, the capture history may include the device ID to identify the imaging device 30 that has captured the facial image, or the installation site of the imaging device 30 that has captured the facial image as illustrated in FIG. 13.

### 5-6. Dashboard Function

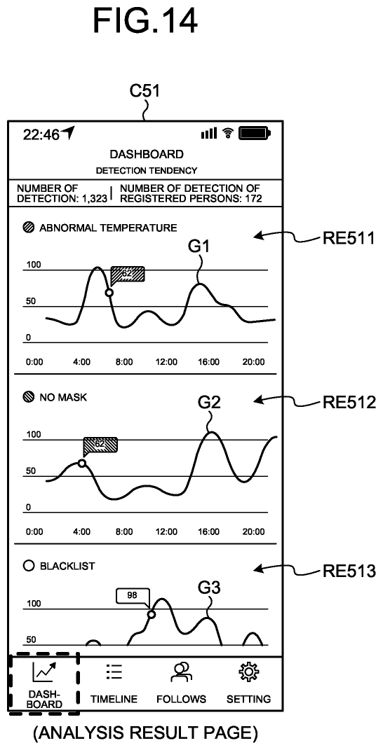

Furthermore, the information processing apparatus 100 has a dashboard function as a tool of visualizing an analysis result by analyzing information about a visitor and summarizing it graphically. In FIG. 14, an example of the dashboard function of the information processing apparatus 100 will be explained.

In the example in FIG. 14, the page control unit 132 controls the display such that an analysis result page C51 is displayed on the terminal device 10 of the user U11 in response to an access from the user U11. For example, the page control unit 132 generates the analysis result page C51 in which an analysis result is displayed by summarizing/analyzing information registered in the visitor information database 122. The page control unit 132 then controls the display such that the analysis result page C51 is displayed on the terminal device 10.

As described so far, an information processing apparatus 200 can determine, from a body temperature detected from a visiting person, whether the person is of the attribute “ABNORMAL “TEMPERATURE”. Moreover, a person that has been determined to be of the attribute “ABNORMAL “TEMPERATURE” can be tagged with a corresponding tag. Because a tagging result is reflected to the visitor information database 122, the page control unit 132 may refer to the visitor information database 122, may analyze how the number of persons determined to be of the attribute “ABNORMAL “TEMPERATURE” varies with time, and may generate the analysis result page C51 in which an analysis result RE511 is displayed. According to the example in FIG. 14, the analysis result RE511 may be displayed in a graph G1 in which a horizontal axis is for “TIME”, and a vertical axis is for “TOTAL NUMBER OF PERSONS”.

Moreover, the user or the information processing apparatus 200 can determine, from a facial image of a visiting person, whether the person is of the attribute “NO MASK”. To the person determined to be of the attribute “NO MASK” can be tagged with a corresponding tag. Because a tagging result is reflected to the visitor information database 122, the page control unit 132 may refer to the visitor information database 122, may analyze how the number of persons determined to be of the attribute “NO MASK” varies with time, and may generate the analysis result page C51 in which an analysis result RE512 is displayed. According to the example in FIG. 14, the analysis result RE512 may be displayed in a graph G2 in which a horizontal axis is for “TIME”, and a vertical axis is for “TOTAL NUMBER OF PERSONS”.

Moreover, as the user can determine, from a facial image of a visiting person, whether the person is of the attribute “BLACKLIST”, the user can add a corresponding tag thereto. Because a tagging result is reflected to the visitor information database 122, the page control unit 132 may refer to the visitor information database 122, may analyze how the number of persons determined to be of the attribute “BLACKLIST” varies with time, and may generate the analysis result page C51 in which an analysis result RE513 is displayed. According to the example in FIG. 14, the analysis result RE513 may be displayed in a graph G3 in which a horizontal axis is for “TIME”, and a vertical axis is for “TOTAL NUMBER OF PERSONS”.

Although the examples in which the attribute information of a subject of analysis is “ABNORMAL TEMPERATURE”, “NO MASK”, “BLACKLIST” has been described in FIG. 14, the attribute of a subject of analysis is not limited to these examples.

For example, suppose that the user U11 has created the “VIP” tag, the “ABNORMAL TEMPERATURE” tag, the “NO MASK” tag, the “MEMBER” tag, and the “SUSPICIOUS INDIVIDUAL” tag. In this case, the page control unit 132 may generate the analysis result page C51 in which a graph corresponding to the respective attribute information is displayed as an analysis result by analyzing the total number of persons varying with time for each of the “VIP” tag, the “ABNORMAL TEMPERATURE” tag, the “NO MASK” tag, the “MEMBER” tag, and the “SUSPICIOUS INDIVIDUAL” tag.

Furthermore, the page control unit 132 may analyze the total number of persons for selected attribute information by having the user U11 select attribute information of a subject of analysis from among the “VIP” tag, the “ABNORMAL TEMPERATURE” tag, the “NO MASK” tag, the “MEMBER” tag, and the “SUSPICIOUS INDIVIDUAL” tag.

### 6. PROCEDURE OF PROCESSING

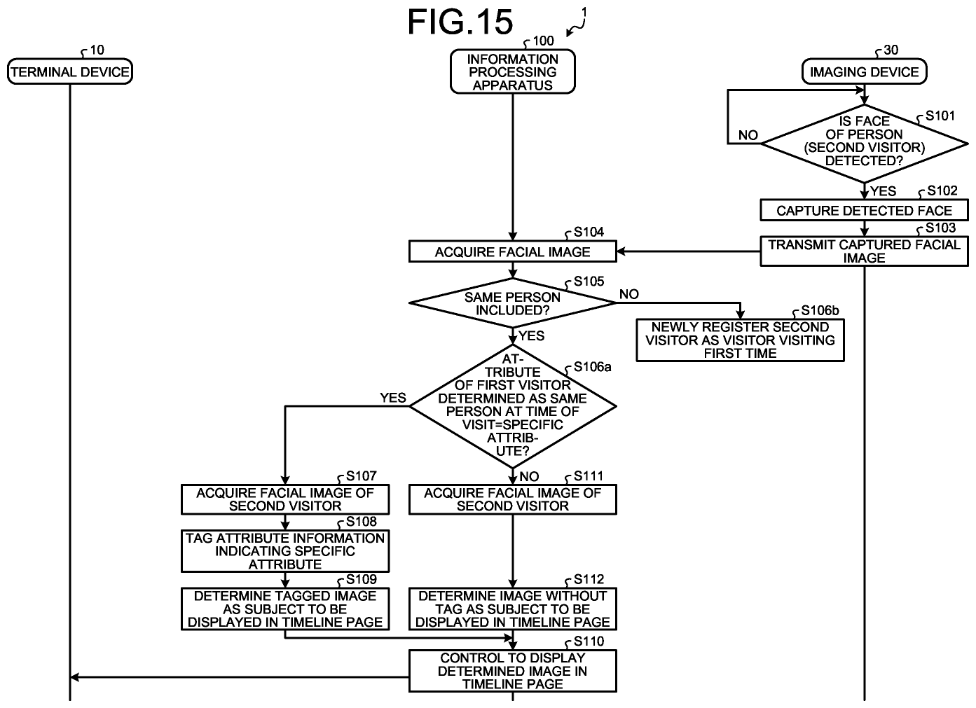

Next, an example of procedure if the information processing according to the embodiment will be explained by using FIG. 15. FIG. 15 is a sequence diagram illustrating a procedure of the information processing according to the embodiment. In FIG. 15, a procedure of information processing performed among respective devices included in the information processing system 1 is illustrated. In the example in FIG. 15, it will be explained, assuming that creation of a tag, addition of a tag to a subject, and various kinds of notification settings are performed by a user.

Moreover, it will be explained, assuming that the imaging device 30 illustrated in FIG. 30 is an imaging terminal that is installed in a predetermined facility FCx, and the terminal device 10 is an information processing terminal that is used by an arbitrary user Ux belonging to the facility FCx. Moreover, in the example in FIG. 15, it is assumed that the user Ux accesses the information processing apparatus 100 by using the terminal device 10 to receive visit notification.

First, the imaging device 30 determines whether a face of a visiting person (second visitor) can be detected in response to a person visiting the facility FCx (step S101). The imaging device 30 waits in standby until a face is detected while face is not detected (step S101: NO).

On the other hand, when a face is detected (step S101: YES), the imaging device 30 captures a facial image of the detected face (step S102).

Furthermore, the imaging device 30 transmits the facial image captured at step S102 to the information processing apparatus 100 (step S103). The imaging device 30 may detect a body temperature of the person also at step S102, and when it is determined as the attribute “ABNORMAL TEMPERATURE” from the detection result, the attribute information “ABNORMAL TEMPERATURE” may be transmitted to the information processing apparatus 100 together with the facial image. Moreover, the imaging device 30 may transmit, when it is determined as the attribute “NO MASK” from the facial image, the attribute information “NO MASK” to the information processing apparatus 100 together with the facial image.

The acquiring unit 131 of the information processing apparatus 100 acquires the facial image transmitted by the imaging device 30 (step S104).

Next, the determining unit 136 of the information processing apparatus 100 performs the same-person determination processing by using the facial image acquired by the acquiring unit 131 (step S105). For example, the determining unit 136 determines whether the same person as the second visitor is included among the first visitors by verification between a facial image registered in the visitor information database 122 (facial image of the first visitor) and the facial image acquired by the acquiring unit 131 (facial image of the second visitor).

When it is determined that the same person as the second visitor is included among the first visitors (step S105: YES), the notifying unit 138 determines whether an attribute of a determination subject at the time of past visit of the first visitor is a specific attribute (step S106a). For example, the notifying unit 138 refers to the visitor information database 122, and determines whether attribute information determined by the user Ux or attribute information dynamically determined by the information processing apparatus 100 is added to the first visitor of the determination subject. When it is determined that the attribute information is added as a tag, the notifying unit 138 can determine that the attribute at the time of past visit of the first visitor of the determination subject is a specific attribute (attribute indicated by a tag). On the other hand, when it is determined that attribute information is not added as a tag, the notifying unit 138 can determine that an attribute at the time of past visit of the first visitor of the determination subject is not a specific attribute.

When it is determined that the attribute at the time of past visit of the first visitor of the determination subject is a specific attribute (step S106a: YES), the notifying unit 138 acquires a facial image of the second visitor (facial image acquired at step S102) (step S107).

Subsequently, the notifying unit 138 tags the facial image acquired at step S107 with attribute information indicating the specific attribute that is a subject at step S106a (step S108). Moreover, the notifying unit 138 determines a tagged image that is tagged at step S108 as a subject to be displayed on the timeline page C21 (step S109).

The notifying unit 138 notifies that the subject person, the attribute of which is a specific attribute at least at the time of past visit has visited again as the second visitor by controlling the display such that the determined image (tagged image) is displayed in the timeline page C21 (step S110).

Returning back to step S106a, when it is determined that the attribute at the time of past visit of the first visitor of a determination subject is not a specific attribute (step S106a: NO), the notifying unit 138 acquires a facial image of the second visitor (facial image captured at step S102) (step S111). The notifying unit 138 determines the facial image acquired at step S107 as it is (that is, image without a tag) as a subject to be displayed in the timeline page C21 (step S112).

Furthermore, in this example, the notifying unit 138 performs visit notification by controlling the display such that the determined image (image without a tag) is displayed in the timeline page C21.

Returning back to step S105, when it is determined that the same person as the second visitor is not included among the first visitors (step S105: NO), the registering unit 137 newly registers the second visitor as a visitor of a first visit to the facility FCx (step S106b). For example, the registering unit 137 issues a new “VISITOR ID” to identify the person of the second visitor as the first visitor, and registers the facial image of the second visitor associating with the issued “VISITOR ID” in the visitor information database 122.

When it is determined that the same person as the second visitor is included among the first visitors (step S105a: YES), the registering unit 137 may register the facial image of the second visitor in the visitor information database 122, associating with the “VISITOR ID” to identify the first visitor of a determination subject.

### 7. CONCLUSION

As explained above, the information processing apparatus 100 according to the embodiment acquires a facial image of the first visitor that has visited a predetermined place to be visited, and attribute information at the time of visit of the first visitor. Moreover, the information processing apparatus 100 determines whether the same person as the second person is included among the first visitors by verifying between the facial image of the first visitor and the facial image of the second visitor.

The information processing apparatus 100 notifies, when it is determined that the same person as the second person is included among the first visitors while the attribute information corresponding to the first visitor that has been determined to be the same person as the second visitor indicates a specific attribute, that the subject person of the specific attribute at least at the time of the above visit visited again as the second visitor.

According to the information processing apparatus 100 as described above, a user that is provided with a service by the information processing apparatus 100 can track future visits of the visitor that has been determined to be of a specific attribute effectively. Moreover, as a result, the user can perform, for example, health management, measures of infectious diseases, crime prevention, sales promotion, business activities, reception operation, or the like appropriately.

### 8. HARDWARE CONFIGURATION

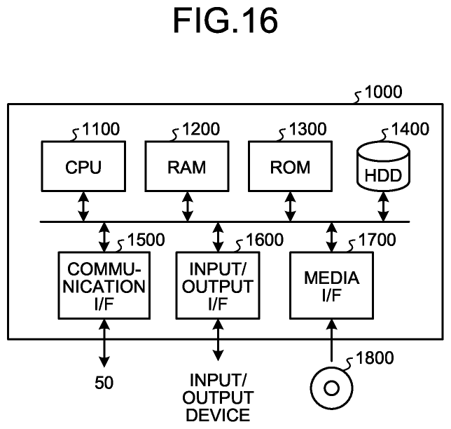

Moreover, the information processing apparatus 100 described above is implemented by a computer 1000 having a configuration as illustrated in FIG. 16. FIG. 16 is a hardware configuration diagram illustrating one example of a computer that implements the functions of the information processing apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and performs a control of the respective parts. The ROM 1300 stores a boot program that is executed by the CPU 1100 at the time of activation of the computer 1000, a program dependent on hardware of the computer 1000, and the like.

The HDD 1400 stores a program executed by the CPU 1100, and data that is used by the program, and the like. The communication interface 1500 receives data from other devices through a predetermined network, to transmit to the CPU 1100, and transmits data generated by the CPU 1100 to other devices through a predetermined network.

The CPU 1100 controls an output device, such as a display and a printer, through the input/output interface 1600, and controls an input device, such as a keyboard and a mouse. The CPU 1100 acquires data from the input device through the input/output interface 1600. Moreover, the CPU 1100 outputs generated data to the output device through the input/output interface 1600.

The media interface 1700 reads a program or data stored in the storage medium 1800, and provides it to the CPU 1100 through the RAM 1200. The CPU 1100 loads the program from the storage medium 1800 to the RAM 1200 through the media interface 1700, and executes the loaded program. The storage medium 1800 is, for example, an optical recording medium, such as a digital versatile disk (DVD) and a phase change rewritable disk (PD), a magneto-optical recording medium such as a magneto-optical disk (MO), a tape medium, a magnetic recording medium, a semiconductor memory, or the like.

For example, when the computer 1000 functions as the terminal device 10, the CPU 1100 of the computer 1000 executes these programs loaded on the RAM 1200, and thereby implements the functions of the control unit 13. The CPU 1100 of the computer 1000 reads these programs from the recording medium 1800, but as another example, these programs can be acquired from other devices through a predetermined communication network.

For example, when the computer 1000 functions as the information processing apparatus 100, the CPU 1100 of the computer 1000 implements the functions of the control unit 130 by executing a program loaded on the RAM 1200.

### 9. OTHERS

Furthermore, out of the processing explained in the respective embodiments described above, all or some of processing explained to be performed automatically can also be performed manually, or all or some of processing explained to be performed manually can also be performed automatically by a publicly-known method. Besides, the procedure of processing, the specific names, and the information including various kinds of data and parameters described in the above document or in the drawings can be arbitrarily changed, unless otherwise specified. For example, the respective information illustrated in the respective drawings is not limited to the information illustrated.

Moreover, the respective components of the respective devices illustrated are of functional concept, and it is not necessarily required to be configured physically as illustrated. That is, specific forms of distribution and integration of the respective devices are not limited to the ones illustrated, and all or some thereof can be configured to be distributed or integrated functionally or physically in an arbitrary unit according to various kinds of loads, use conditions, and the like.

Furthermore, the respective embodiments described above can be arbitrarily combined within a range not causing a contradiction in the processing.

Some of embodiments of the present application have so far been explained in detail with reference to the drawings, but these are examples and the present invention can be implemented by other forms in which various modifications and improvements are made therein including modes described in a field of disclosure of the invention based on knowledge of those skilled in the art.

Moreover, the term “section, module, unit” described above can be replaced with “means”, “circuit”, or the like. For example, the acquiring unit can be read as acquiring means or acquiring circuit.

According to one aspect of the embodiment, future visits of a visitor that has been determined to be of a specific attribute can be effectively tracked.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquiring unit that acquires a facial image of a first visitor that has visited a predetermined place to be visited, and attribute information indicating an attribute of the first visitor at a time of visit;
a determining unit that determines, when a second visitor visits the predetermined place to be visited, whether a same person as the second visitor is included among the first visitor by verification between a facial image of the first visitor and a facial image of the second visitor; and
a notifying unit that notifies, when attribute information corresponding to the first visitor that has been determined as the same person as the second visitor indicates a specific attribute, that a subject person, an attribute of which is the specific attribute at least at the time of visit has visited again as the second visitor.

2. The information processing apparatus according to claim 1, wherein
the determining unit determines whether the same person as the second visitor is included among the first visitor each time a facial image of each of the second visitor is captured, by verifying between the captured facial image of the second visitor and the facial image of the first visitor in real time, and
the notifying unit notifies, when it is determined that the same person as the second visitor is included among the first visitors, that the subject person has visited again on a timeline page that is a page in which the facial image of the second visitor is displayed chronologically according to a date and time of capture in real time.

3. The information processing apparatus according to claim 2, wherein
the notifying unit notifies that the subject person has visited again by tagging attribute information indicating the specific attribute to the facial image of the subject person out of facial images of the second visitor that are displayed chronologically in the timeline page in a list.

4. The information processing apparatus according to claim 1, further comprising
a registering unit that performs information registration to a predetermined storage unit according to a determination result obtained by the determining unit.

5. The information processing apparatus according to claim 4, wherein
the registering unit registers, when it is determined that the same person as the second visitor is included among the first visitors, registers the facial image of the second visitor in the predetermined storage unit, associating with identification information to identify the first visitor that has been determined as the same person as the second visitor.

6. The information processing apparatus according to claim 4, wherein
the registering unit registers, when it is determined that the same person as the second visitor is not included among the first visitors, issues identification information to identify the second visitor as a new visitor, and registers the facial image of the second visitor in the predetermined storage unit, associating with the issued identification information.

7. The information processing apparatus according to claim 5, wherein
the registering unit registers, when the visitor is recognized as a specific attribute from a detection result obtained by detection with respect to the visitor by an imaging device installed in the predetermined place to be visited, attribute information indicating the specific attribute in the predetermined storage unit, associating with the identification information.

8. The information processing apparatus according to claim 7, wherein
the specific attribute is either one of abnormal temperature and no mask.

9. The information processing apparatus according to claim 1, further comprising
a setting accepting unit that accepts information settings relating to a notification mode by the notifying unit from a user.

10. The information processing apparatus according to claim 9, wherein
the setting accepting unit accepts attribute information of a notification subject indicating when a person of what kind of attribute visits, visit notification is to be performed for the user, and
the notifying unit performs notification according to the attribute information of the notification subject.

11. The information processing apparatus according to claim 10, wherein
the setting accepting unit accepts first attribute information that is attribute information to notify of a visit each time a person of a specific attribute visits, and that indicates the specific attribute, as attribute information of the notification subject, and
the notifying unit notifies, when the second visitor is recognized as an attribute indicated by the first attribute information at a time when the second visitor visits, that a person of the attribute indicated by the first attribute information has visited, regardless of whether the same person as the second visitor is included among the first visitors.

12. The information processing apparatus according to claim 10, wherein
the setting accepting unit accepts second attribute information attribute information to notify that a person of a specific attribute has visited again, and that indicates the specific attribute, as attribute information of the notification subject, and
the notifying unit notifies, when attribute information corresponding to the first visitor that has been determined as the same person as the second visitor is the second attribute information, that a subject person, an attribute of which is an attribute indicated by the second attribute information at least at the time of visit has visited again as the second visitor.

13. The information processing apparatus according to claim 12, wherein
the setting accepting unit further accepts designation of a subject of tagging to which the second attribute information is tagged out of visitors that have visited the predetermined place to be visited, and when the subject of tagging is designated, stores the second attribute information as attribute information indicating an attribute at a time of visit of the first visitor, associating with a facial image of the subject of tagging.

14. The information processing apparatus according to claim 13, wherein
when a predetermined period has passed since the second attribute information is added to the subject of tagging, the setting accepting unit removes addition of the second attribute information from the second attribute information.

15. The information processing apparatus according to claim 9, wherein
the setting accepting unit further accepts designation of an imaging device to be used, indicating a person that is captured by which one of the imaging device is to be a subject of visit notification out of imaging devices associated with the user.

16. An information processing method that is performed by an information processing apparatus, the method comprising:
acquiring a facial image of a first visitor that has visited a predetermined place to be visited, and attribute information indicating an attribute of the first visitor at a time of visit;
determining, when a second visitor visits the predetermined place to be visited, whether a same person as the second visitor is included among the first visitor by verification between a facial image of the first visitor and a facial image of the second visitor; and
notifying, when attribute information corresponding to the first visitor that has been determined as the same person as the second visitor indicates a specific attribute, that a subject person, an attribute of which is the specific attribute at least at the time of visit has visited again as the second visitor.

17. A non-transitory computer readable storage medium having stored therein an information processing program that causes a computer to execute:
acquiring a facial image of a first visitor that has visited a predetermined place to be visited, and attribute information indicating an attribute of the first visitor at a time of visit;
determining, when a second visitor visits the predetermined place to be visited, whether a same person as the second visitor is included among the first visitor by verification between a facial image of the first visitor and a facial image of the second visitor; and
notifying, when attribute information corresponding to the first visitor that has been determined as the same person as the second visitor indicates a specific attribute, that a subject person, an attribute of which is the specific attribute at least at the time of visit has visited again as the second visitor.
